(19) United States
(12) Patent Application Publication
(10) Pub. No.: US 2024/0298230 A1
(43) Pub. Date: Sep. 5, 2024

(54) FIRST WIRELESS DEVICE, SECOND WIRELESS DEVICE, NETWORK NODE, AND METHODS PERFORMED THEREBY, FOR HANDLING DETECTION OF CELLS NEIGHBORING A FIRST CELL SERVING THE FIRST WIRELESS DEVICE

(71) Applicant: Telefonaktiebolaget LM Ericsson (publ), Stockholm (SE)

(72) Inventors: Konstantinos VANDIKAS, Solna (SE); Selim ICKIN, Danderyd (SE); Jalil TAGHIA, STOCKHOLM (SE); Wenfeng HU, TÄBY (SE)

(73) Assignee: Telefonaktiebolaget LM Ericsson (publ), Stockholm (SE)

(21) Appl. No.: 18/575,788

(22) PCT Filed: Jul. 2, 2021
(86) PCT No.: PCT/SE2021/050676

§ 371 Date: Dec. 29, 2023

(51) Int. Cl. H04W 36/00

(52) U.S. Cl. CPC H04W 36/0085; H04W 36/0011

(57) ABSTRACT

A method performed by a first wireless device (131). The method is for handling detection of cells neighboring a first cell (121) serving the first wireless device (131). The first wireless device (131) receives (307), from another wireless device (134), via device to device communication, a) a first request to collect one or more respective measurements on cells detected by the first wireless device (131), b) a first indication indicating the first cell (121) served by a network node (110) that the request for the one or more respective measurements originates from, and c) a second indication indicating a session to which the request belongs. The first wireless device (131) sends (310), to at least a second wireless device (132), via device to device communication, a) a second request to collect one or more respective measurements on cells detected by the second wireless device (132), b) the first indication, and c) the second indication.

### TECHNICAL FIELD

The present disclosure relates generally to a first wireless device and methods performed thereby for handling detection of cells neighboring a first cell serving the first wireless device. The present disclosure also relates generally to a second wireless device, and methods performed thereby for handling detection of cells neighboring the first cell serving the second wireless device. The present disclosure further relates generally to a network node, and methods performed thereby for handling detection of cells neighboring the first cell.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. In Third Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is, a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g., conventional mobile phones and smart phones. In the context of and growth of the IoT, it is evident that MTC traffic will be increasing and may thus need to be increasingly supported in wireless communication systems.

### Automatic Neighbor Relations (ANR)

ANR may be understood as a device Self-Organizing Networks (SON) feature that was originally standardized for Third Generation (3G) Long Term evolution networks. ANR may be understood to allow detecting nearby nodes and/or cells thus facilitating load balancing and/or handovers, but also interference detection.

An overview of the ANR function 1 is provided in FIG. 1. A neighbour detection function 2 run on an eNB 3 may be understood to be responsible for finding new neighbours and adding them to a Neighbor Relations Table (NRT) 4. A Neighbour Removal Function 5 may enable to remove NRs. Both the Neighbour Detection Function 2 and the Neighbour Removal Function 5 may be implementation specific. An existing Neighbour cell Relation (NR) 6 from a source cell to a target cell may be understood to mean that an eNB controlling the source cell may know the E-UTRAN Cell Global Identifier (ECGI)/Cell Global Identifier (CGI) and Physical Cell Identifier (PCI) of the target cell and may have an entry in the NRT 4 for the source cell identifying the target cell, with a Target Cell Identifier (TCI). The ANR function 1 may rely on cells broadcasting their identity on a global level, e.g., the E-UTRAN Cell Global Identifier (ECGI), and may allow Operations & Maintenance (O&M) 7 to manage the NRT 4. O&M 7 may be enabled to add and delete NRs via an NRT Management Function 8. It may also change the attributes 9 of the NRT, such as “No remove”, which may be understood to mark entries that should not be removed, “No HO”, which may be understood to indicate that there should be no hand over to that cell, and “No X2”, which may be understood to mean that the eNB 3 may not have an X2 physical link to the node managing the target cell. The O&M 7 system may be informed about changes in the NRT, e.g., via an NR report 10. The management of requests and reports may be performed via Radio Resource Control (RRC) 11. NRs may also be removed based on Internal Information of the eNB.

Prior to the introduction of the ANR feature, the task of detecting nearby nodes and/or cells was dealt manually by driving around different areas and collecting measurements from nearby cells. If it is taken into consideration that mobile networks are becoming denser and denser, such an option may be understood to not be viable, hence the introduction of ANR. ANR may work actively or passively; actively, by periodically asking one or more UEs which are attached to a cell, to provide a report on the other cells they can listen to; passively, with UEs providing such measurements periodically to the cell they are attached to. This information may then be stored in the cell's Neighbor Relation Table (NRT) table 4.

In spite of its benefits, existing methods to perform ANR may be hard to scale and may have high overhead, which may result in a poor performance of the network.

### SUMMARY

As part of the development of embodiments herein, one or more challenges with the existing technology will first be identified and discussed.

Two problems have been identified in the state of the existing methods with regards to ANR. The first problem relates to the fact that ANR necessitates extra signaling between base stations and each connected UE. Since the number of connected devices increases over the years significantly, there may be understood to be a risk for signal overflow, where the base stations may need higher and higher computation and network resources to handle the signaling between base station and UEs. Hence, existing methods with regards to ANR may be understood to be hard to scale.

The first problem relates to the fact that ANR is privacy invasive since it allows a compromised cell, e.g., a requesting cell, to inspect such updates which may be coming from UEs, and identify their location. Typical solutions which may be applied to such problems are techniques from the area of Secure Multi Party Computation (SMC) and/or Differential Privacy. However, solving this problem with techniques from SMC may be understood to come with its own set of challenges. SMC is computationally expensive since different inputs may be understood to need to be encrypted and shared among the participants. This makes the use of SMC inappropriate for low-powered embedded devices. It may also require additional messages to be passed around the involved parties in order to recreate the NRT table. For example, if Secure Aggregation, which belongs to the SMC family, is considered, the messaging cost may be understood to be O(n\hat{ }2), where n is the number of participants. A typical eNB may have at least a few thousand active RRC connections on average on a daily basis. The latter problem may be resolved by sampling. That is, instead of using all UEs, a few may be randomly chosen to use. However, the risk here may be understood to be that an incomplete NRT table may be obtained due to the very low number of participants, or this process may need to be performed multiple times, which will come at the cost of renegotiating a random mask for each iteration.

Another way to solve this problem may be to use Differential Privacy, which may be understood to mean that a certain noise, or E, may be added randomly, that is, retrieved from a Laplacian distribution, every time a eNB may ask a UE for this information. The main problem here may be understood to be that this may be typically bound by a certain number of requests, which may be understood to mean that if a cell queries the same UE frequently enough, eventually it may uncover this parameter, which may then reveal the truth about the location of the UE. This may be understood to be because, if a UE is asked the same persistently enough, the noise may be revealed and the location of the UE may then be derived.

It is an object of embodiments herein to improve the handling of neighbor cell detection. Particularly, it may be understood to be an object of embodiments herein to improve the handling detection of cells neighboring a cell serving a wireless device.

According to a first aspect of embodiments herein, the object is achieved by a method, performed by a first wireless device. The method is for handling detection of cells neighboring a first cell serving the first wireless device. The first wireless device operates in a wireless communications network. The first wireless device receives from another wireless device operating in the wireless communications network, via device to device communication, a first request. The first request is to collect one or more respective measurements on cells detected by the first wireless device. The first wireless device also receives a first indication indicating the first cell served by a network node that the request for the one or more respective measurements originates from. The first wireless device further receives, a second indication indicating a session to which the request belongs. The first wireless device sends, to at least a second wireless device operating in the wireless communications network, via device to device communication, a second request to collect one or more respective measurements on cells detected by the second wireless device. The first wireless device also sends the first indication indicating the first cell served by the network node that the request for the one or more respective measurements originates from. The first wireless device further sends, the second indication indicating the session to which the request belongs.

According to a second aspect of embodiments herein, the object is achieved by a method, performed by the second wireless device. The method is for handling detection of cells neighboring the first cell serving the first wireless device. The first wireless device operates in the wireless communications network. The second wireless device receives, from at least one first wireless device operating in the wireless communications network, via device to device communication, the second request. The second request is to collect one or more respective measurements on cells detected by the second wireless device—The second wireless device also receives the first indication indicating the first cell served by the network node that the request for the one or more measurements originates from. The second wireless device further receives the second indication indicating the session to which the request belongs, and a third indication indicating the one or more respective measurements on the cells detected by the first wireless device. The second wireless device also collects, based on the received second request, the one or more respective measurements on cells detected by the second wireless device. The second wireless device also sends to the network node operating in the wireless communications network, the network node serving the first cell, a further indication indicating the collected one or more respective measurements on the cells detected by the second wireless device. The second wireless device further sends to the network node the one or more respective measurements on the cells detected by the at least one first wireless device.

According to a third aspect of embodiments herein, the object is achieved by a method, performed by the network node. The method is for handling detection of cells neighboring the first cell. The network node operates in the wireless communications network. The network node sends, to at least a wireless device operating in the wireless communications network, a request to collect one or more respective measurements on cells detected by the wireless device. The network node also sends the first indication indicating the first cell, and the second indication indicating the session to which the first request belongs. The network node receives, from a different wireless device, a further indication. The further indication indicates collected one or more respective measurements on cells detected by at least the wireless device and the different wireless device. The receiving is performed in the absence of receiving a respective identity of the wireless device and the different wireless device.

According to a fourth aspect of embodiments herein, the object is achieved by the first wireless device, for handling detection of cells neighboring the first cell configured to serve the first wireless device. The first wireless device is configured to operate in the wireless communications network. The first wireless device is further configured to receive, from the another wireless device configured to operate in the wireless communications network, via device to device communication, the first request. The first request is to collect one or more respective measurements on cells configured to be detected by the first wireless device. The first wireless device is further configured to receive the first indication. The first indication is configured to indicate the first cell configured to be served by the network node that the request for the one or more respective measurements is configured to originate from. The first wireless device is further configured to receive the second indication. The second indication is configured to indicate the session to which the request is configured to belong. The first wireless device is further configured to send, to at least the second wireless device configured to operate in the wireless communications network, via device to device communication, the second request. The second request is to collect one or more respective measurements on cells configured to be detected by the second wireless device. The first wireless device is further configured to send the first indication being configured to indicate the first cell configured to be served by the network node that the request for the one or more respective measurements is configured to originate from. The first wireless device is further configured to send the second indication configured to indicate the session to which the request is configured to belong.

According to a fifth aspect of embodiments herein, the object is achieved by the second wireless device, for handling detection of cells neighboring the first cell configured to serve the second wireless device. The second wireless device is configured to operate in the wireless communications network. The second wireless device is further configured to receive, from at least one first wireless device configured to operate in the wireless communications network, via device to device communication, the second request. The second request is to collect one or more respective measurements on cells configured to be detected by the second wireless device. The second wireless device is further configured to receive the first indication configured to indicate the first cell being configured to be served by the network node that the request for the one or more measurements is configured to originate from. The second wireless device is further configured to receive the second indication configured to indicate the session to which the request is configured to belong, The wireless device is further configured to receive the third indication configured to indicate the one or more respective measurements on the cells configured to be detected by the first wireless device. The second wireless device is further configured to collect, based on the second request configured to be received, the one or more respective measurements on cells configured to be detected by the second wireless device. The second wireless device is also configured to send, to the network node configured to operate in the wireless communications network, the network node being configured to serve the first cell, the further indication. The further indication is configured to indicate the one or more respective measurements configured to be collected on the cells configured to be detected by the second wireless device. The further indication is further configured to indicate the one or more respective measurements on the cells configured to be detected by the at least one first wireless device.

According to a sixth aspect of embodiments herein, the object is achieved by the network node, for handling detection of cells neighboring the first cell. The network node is configured to operate in the wireless communications network. The network node is further configured to send, to at least the wireless device configured to operate in the wireless communications network, the request to collect one or more respective measurements on cells configured to be detected by the wireless device. The network node is further configured to send, to at least the wireless device configured to operate in the wireless communications network, the first indication configured to indicate the first cell. The network node is further configured to send, to at least the wireless device configured to operate in the wireless communications network, the second indication. The second indication is to indicate the session to which the first request is configured to belong. The network node is also configured to receive, from the different wireless device, the further indication. The further indication is configured to indicate one or more respective measurements configured to be collected on cells configured to be detected by at least the wireless device and the different wireless device. The receiving is configured to be performed in the absence of receiving the respective identity of the wireless device and the different wireless device.

By the first wireless device receiving the first request, or the second wireless device receiving the second request, the first wireless device, or the second wireless device, respectively, may be enabled to gather information on the neighboring cells to the first cell and thereby ultimately assist the network node in obtaining that information. This may be understood in turn to enable that the requesting network node and/or cell may be offloaded from having to itself query each wireless device that may have an active connection with it, in order to get such information. Instead, the process may be delegated to the different wireless devices served by the first cell, such as the first wireless device and the second wireless device, and the network node, via the first cell, may only receive the final result, in the further indication. The offloading may be understood to represent less energy consumption for the network node, less signalling, and smaller computation cost.

By the first wireless device, or the second wireless device, receiving the first indication, it may be ensured that this scanning or sweeping process may remain within the coverage boundaries of the requesting cell. If the first indication were not to indicate the first cell serving the first wireless device, or the second wireless device, respectively, then the first wireless device, or the second wireless device, may be able to ignore this request.

By the first wireless device, or the second wireless device, receiving the second indication, it may be ensured that as many wireless devices as possible may be requested to perform the respective measurements while also avoiding asking the same wireless device twice. Further, this may be ensured without having to remember which wireless devices have already been asked, since that would break privacy. The wireless devices may be allowed to record the second indication that they may have received a request for, and also the point in time they may have received the request. If the first wireless device, or the second wireless device, were to see that the first request, or the second request, respectively has been received more than once, they may reject the new request.

By sending the second request to at least the second wireless device, the first wireless device may ensure that the respective measurements of as many different wireless devices served by the first cell as possible may be collected on neighboring cells, so that the network node may ultimately obtain a report on all detected neighboring cells, which may be as complete as possible. That is, after the first wireless device may have collected its respective one or more measurements, the first wireless device may propagate, via device to device communication, the request to other wireless devices within its radio range, so that the request may reach as many different wireless devices as possible, while offloading the network node.

By receiving the second request comprising the one or more respective measurements on the cells detected by the first wireless device, the second wireless device, may be enabled to collect the respective one or more measurements on the cells it may detect, e.g., above a certain threshold, and then send to the network node, in the further indication, its own respective measurements along with the one or more respective measurements collected and received by the first wireless device.

Since the output that may be produced by this process may be understood to be aggregated, it may not be possible for the first cell, that is, the network node, to identify the location of the wireless devices that may have contributed to this compilation. Hence, embodiments herein may further provide the advantage of enabling to maintain the privacy of the wireless devices involved.

By the network node sending the request to the wireless device, such as the first wireless device, and receiving the further indication from a different wireless device, such as the second wireless device, the network node may achieve to collect information on neighbor relations, while avoiding to itself contact each of the wireless devices served by the first cell, and obtaining individual reports from each of the wireless devices. As explained above, the resulting offloading may be understood to represent less energy consumption for the network node, less signalling, and smaller computation cost.

### BRIEF DESCRIPTION OF THE DRAWINGS

Examples of embodiments herein are described in more detail with reference to the accompanying drawings, according to the following description.

FIG. 1 is a schematic diagram an overview of ANR, according to existing methods.

FIG. 2 is a schematic diagram an example of a wireless communications network, according to embodiments herein.

FIG. 3 is a flowchart depicting a method in a first wireless device, according to embodiments herein.

FIG. 4 is a flowchart depicting a method in a second wireless device, according to embodiments herein.

FIG. 5 is a flowchart depicting a method in a network node, according to embodiments herein.

FIG. 6 is a schematic diagram illustrating an overview of a problem space, according to embodiments herein.

FIG. 7 is a flowchart depicting a first example of a method in a wireless communications network, according to embodiments herein.

FIG. 8 is a flowchart depicting a second example of a method in a wireless communications network, according to embodiments herein.

FIG. 9 is a schematic block diagram illustrating two embodiments, in panel a) and panel b), of a first wireless device, according to embodiments herein.

FIG. 10 is a schematic block diagram illustrating two embodiments, in panel a) and panel b), of a second wireless device, according to embodiments herein.

FIG. 11 is a schematic block diagram illustrating two embodiments, in panel a) and panel b), of a network node, according to embodiments herein.

### DETAILED DESCRIPTION

Certain aspects of the present disclosure and their embodiments may provide solutions to these or other challenges. From a general point of view, embodiments herein may be generally understood to relate to privacy-aware automatic neighbor relations. More particularly, embodiments herein may be understood to make use of device to device communication, e.g., Device to Device Communication (D2D), which may enable a device to directly communicate with another device, assuming the latter device may be in proximity with the first, and also the use of a gossip protocol to disseminate this information from one device to another.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

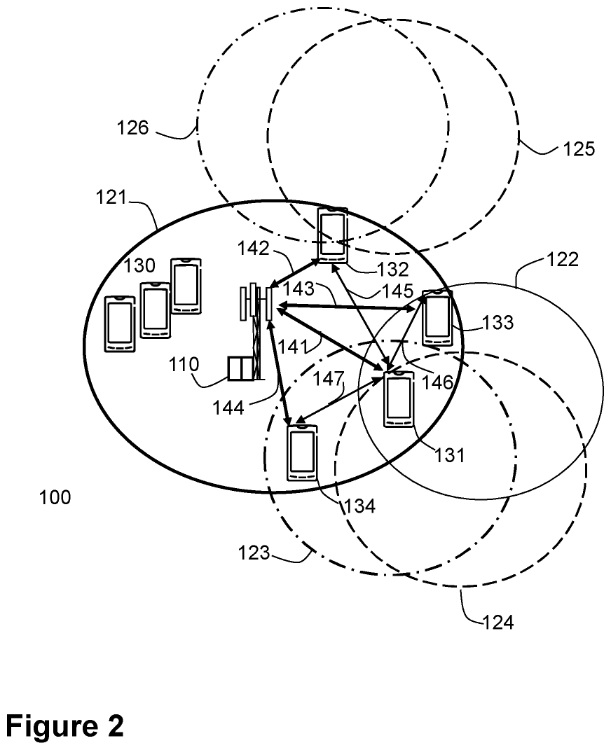

FIG. 2 depicts two non-limiting examples of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. The wireless communications network 100 may typically support MTC, eMTC, IoT and/or NB-IoT. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE LAA, eLAA, feLAA and/or MulteFire. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system, such as for example a system younger than 5G, with similar functionality to that enabling to implement the embodiments herein. Thus, although terminology from 5G/NR and LTE may be used in this disclosure to exemplify embodiments herein, this should not be seen as limiting the scope of the embodiments herein to only the aforementioned system.

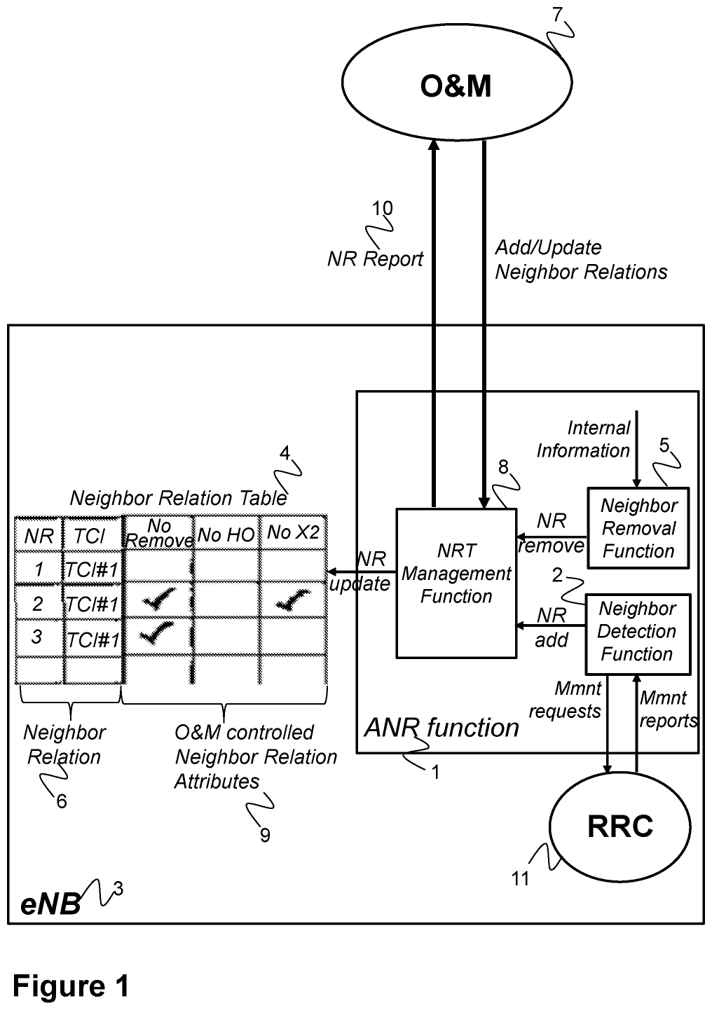

The wireless communications network 100 may comprise a plurality of network nodes, whereof a network node 110 is depicted in the non-limiting example of FIG. 1. The network node 110 is a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, which are not depicted in FIG. 1, the network node 110 may be a distributed node, and may partially perform its functions in collaboration with a virtual node in a cloud.

The wireless communications network 100 may cover a geographical area, which in some embodiments may be divided into cell areas, wherein each cell area may be served by a radio network node, although, one radio network node may serve one or several cells. In the example of FIG. 1, the network node 110 serves a first cell 121. The network node 110 may be of different classes, such as, e.g., macro eNodeB, home eNodeB or pico base station, based on transmission power and thereby also cell size. In some examples, the network node 110 may serve receiving nodes with serving beams. The radio network node may support one or several communication technologies, and its name may depend on the technology and terminology used. Any of the radio network nodes that may be comprised in the communications network 100 may be directly connected to one or more core networks.

The wireless communications network 100 may further comprise one or more cells neighboring the first cell 121. In the non-limiting example of FIG. 1, the cells neighboring the first cell 121 comprise a second cell 122, a third cell 123, a fourth cell 124, a fifth cell 125, a sixth cell 126, although this may be understood as an illustrative example. There may be more or fewer cells neighboring the first cell 121. Each of the cells neighboring the first cell 121 may be served by a respective network node, which in some examples, may be the same respective network node.

A plurality of wireless devices, e.g., a plurality of first wireless devices 130, may be located in the wireless communication network 100, whereof a first wireless device 131, a second wireless device 132, a third wireless device 133 and another wireless device 134, also referred to as a fourth wireless device 134, is depicted in the non-limiting example of FIG. 1. Any of the first wireless device 131, the second wireless device 132, the third wireless device 133 and the another wireless device 134 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. Any of the first wireless device 131, the second wireless device 132, the third wireless device 133 and the another wireless device 134 comprised in the wireless communications network 100 may be enabled to communicate wirelessly in the wireless communications network 100. The communication may be performed directly, e.g., via device to device communication, e.g., D2D, or indirectly, e.g., via a RAN, and possibly one or more core networks, which may comprised within the wireless communications network 100.

The first wireless device 131 may be configured to communicate within the wireless communications network 100 with the network node 110 over a first link 141, e.g., a radio link. The second wireless device 132 may be configured to communicate within the wireless communications network 100 with the network node 110 over a second link 142, e.g., a radio link. The third wireless device 133 may be configured to communicate within the wireless communications network 100 with the network node 110 over a third link 143, e.g., a radio link. The another wireless device 134 may be configured to communicate within the wireless communications network 100 with the network node 110 over a fourth link 144, e.g., a radio link. The first wireless device 131 may be configured to communicate within the wireless communications network 100 with the second wireless device 132 over a fifth link 145, e.g., a radio link. The first wireless device 131 may be configured to communicate within the wireless communications network 100 with the third wireless device 133 over a sixth link 146, e.g., a radio link. The first wireless device 131 may be configured to communicate within the wireless communications network 100 with the another wireless device 134 over a seventh link 147, e.g., a radio link. Any of the wireless devices comprised in the wireless communications network 100 may be understood to be enabled to communicate via a direct link. All links are not represented in FIG. 1 in order to simplify the figure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth”, “fifth”, “sixth” and/or “seventh” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

### General Description

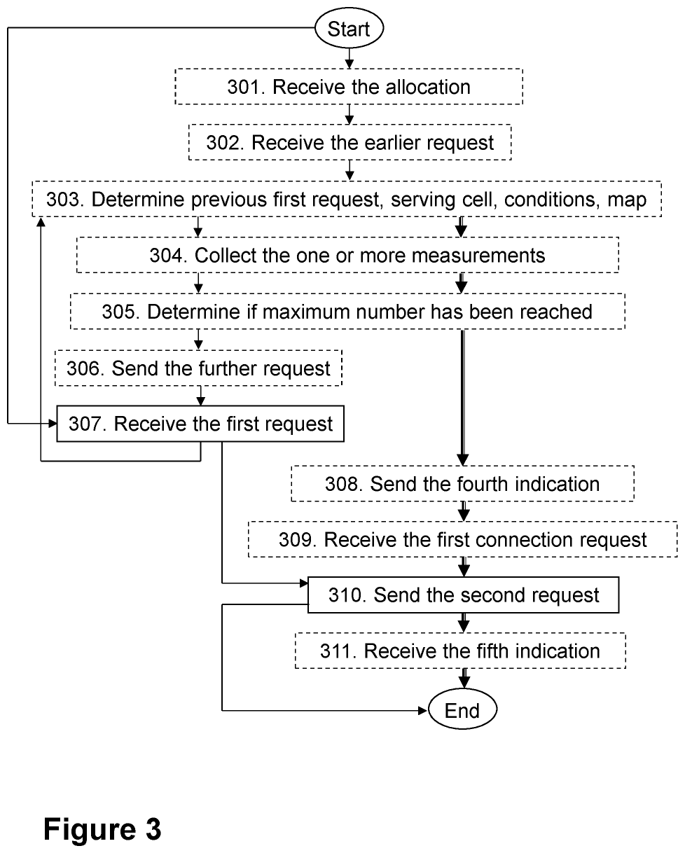

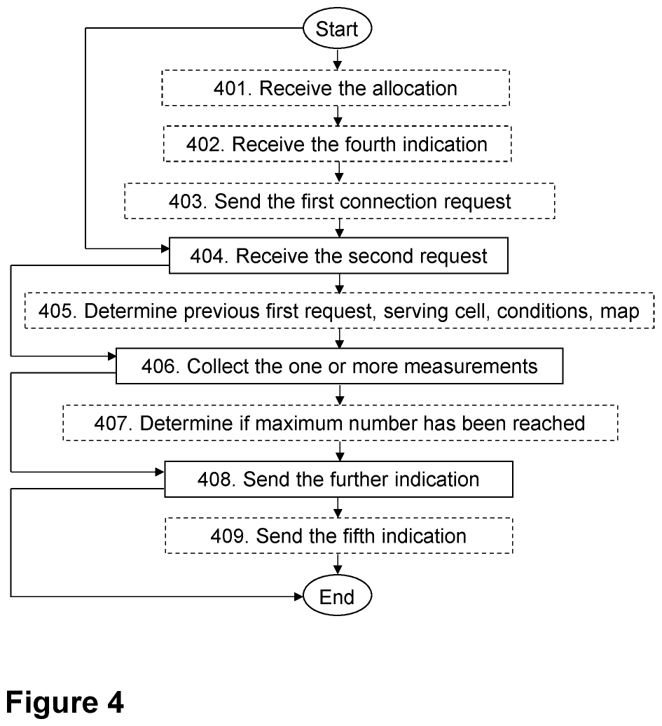

Prior to describing the methods performed by each of the entities involved in embodiments herein, a general overview of the methods performed by these entities, as described in relation to FIG. 2, FIG. 3 and FIG. 4, may be helpful.

In the course of communications in the wireless communications network 100, the network node 110 may be interested in knowing which cells may be neighboring one of its cells. In embodiments herein, for illustrative purposes, this cell is the first cell 121. The network node 110 may be interested in knowing this to, for example, handle handover decisions, among other processes. A cell may be considered to be neighboring the first cell 121, if the wireless devices served by the first cell 121 may be able to detect the cell, e.g., with a measurement above a certain threshold.

Whenever the network node 110 may send, in the first cell 121, a request to find out which cells may be neighboring the first cell 121, the first cell 121 may be understood to be the “requesting cell”, even if the request may be understood to originate in the network node 110 serving it, and not the cell itself. However “requesting cell” is used to refer to the fact that the request may be understood to have been sent, by the network node 110, in that cell, here, the first cell 121.

According to embodiments herein, instead of the network node 110 via the first cell 121, that is, the requesting cell, querying every available wireless device, as, e.g., retrieved from a list of active RRC connections, it may instead pick one or more wireless devices, randomly, e.g., the first wireless device 131. The request sent by the network node 110 may be identified with an identifier. Each of those wireless devices, e.g., UEs, randomly picked by the network node 110, may receive a same identifier to uniquely identify this request. This identifier may be, e.g., a Cell Group Identifier (CGI) session Identifier (ID). A session ID may be provided in order to identify a particular session, and prevent wireless devices from participating in the process more than once.

Each wireless device may then be asked to produce a list of the nodes and/or cells, and, optionally, different Radio Access Technologies (RATs) and also frequencies, that it may be able to listen to, over a certain threshold t. The threshold may be communicated by the requesting cell, or it may be a predefined value that the wireless device may already know. The purpose of the threshold t may be understood to be to filter out those nodes and/or cells that may have a strong signal from the ones that may have a weak signal.

The selected wireless devices, herein, the first wireless device 131, denoted as UE2, the second wireless device 132, denoted as UE3, the third wireless device 133, denoted as UE0, and the another wireless device 134, denoted as UE1, may perform their respective one or more respective measurements on surrounding cells, and may collect the respective results of their measurements. Each wireless devices' input may be represented as a matrix with a single row and multiple columns. Every column may indicate the identifier of the heard cells, e.g., an CGI ID, that the respective wireless device may be able to listen to. These tables may only have one row which may contain the number of times a CGI ID may have been heard.

According to embodiments herein, the selected wireless devices, which may be collectively denoted as S₀=<UE1, UE2, UE3 . . . . UEN, may not return their input immediately back to the requesting cell, the first cell 121, but may instead broadcast this information to nearby wireless devices, producing a new set, S₁, of wireless devices collecting input, which may then add their respective input to the S₀ original input.

In some examples, S₀ may contain a single wireless device.

This process may continue in order to cover every available wireless device that may be connected to the first cell 121, e.g., identified by CGI1, which in this case may be understood to be the identifier of the requesting cell that initiated this request. Since each wireless device may broadcast this information which may then be summarized, it may be understood to be important to avoid asking the same wireless device twice. It may also be understood to also be important to cover as many wireless devices as possible. To avoid asking the same wireless device twice without remembering which wireless devices have already been asked, since that would break privacy, the wireless devices may be allowed to record the CGI session ID that they may have received a request for, and also the point in time they may have received this request. If the wireless devices see that such a request has been received more than once, they may reject the second request. If a wireless device that is connected to another node and/or cell with a different CGI ID, requesting cell ID, then that wireless device may ignore this request. This may be understood to ensure that this scanning or sweeping process may remain within the coverage boundaries of the requesting cell.

This process is illustrated with an example below:

The input from UE1 may be represented in the following Table 1:

TABLE 1

| Available CGIs | CGI1 (requesting cell ID) | CGI2 | CGI3 |
|---|---|---|---|
| # RSRP > t | 1 | 1 | 1 |

The input from UE2 may be represented in the following Table 2:

TABLE 2

| Available CGIs | CGI1 (requesting cell ID) | CGI3 | CGI5 |
|---|---|---|---|
| # RSRP > t | 1 | 1 | 1 |

The result of adding the input from UE1 and UE2, that is, the UE1+UE2 input, in the adding operation referred to previously may be represented in the following Table 3. When UE2 receives UE1's input, it may repeat this measurement in its on environment, thus producing UE2 and then adding that to the input provided by UE, 1 which may yield the table below.

TABLE 3

| | CGI1 (requesting cel ID) | CGI2 | CGI3 | CGI5 |
|---|---|---|---|---|
| # aggregated input | 2 | 1 | 2 | 1 |

The second step, wherein UE2 may receive these measurements and may complement them, e.g., may add, its own may be repeated until the number of wireless devices that may listen to CGI1, the same ID as the requesting cell ID, may reach a certain margin m, that is, the maximum number of devices, which may be required to be smaller or equal to the number of active RRC connections in the requesting cell in the worst case scenario. When that occurs, one final UE may end this cycle. The final UE may be determined either by a threshold or by the maximum number of RRC connections within the requesting cell. The last wireless device may send back the final input, which may be understood to be a summary that may contain how many wireless devices may listen to different cells. Since only the summary may be received by the network node 110 via the first cell 121, the requesting cell may be understood to be incapable of identifying which wireless device may listen to which node and/or cell, but may have enough information to use in its NRT table. Hence, privacy may be maintained while at the same time enabling collection of the neighbor cell relations that the network node 110 may be interested in knowing.

Embodiments herein may rely on Device to Device communication, e.g., or D2D, which was initially introduced in LTE, Release 12, to enable LTE to become a competitive broadband communication technology for public safety networks used by first responders. Ever since then, the idea has expanded to be used in other contexts, for example, to offload an overloaded network, or in mission critical cases, such as vehicle-to-vehicle communication.

In the scope of embodiments herein, the term discovery may be understood to refer to a direct discovery, as opposed to e.g., an Evolved Packet Core (EPC)-level discovery which may be understood to be assisted by EPC nodes and, as such, break privacy. The discovery of each wireless device may start with a push mechanism, where a wireless device may broadcast its presence, while at the same time another wireless device may make use of a pull mechanism, which may be capable of intercepting such requests.

It may be noted that the information that the wireless devices may be tasked to share may be part of control plane data. Therefore, there may be understood to be no cost, subscription-wise, involved for the wireless devices.

Embodiments of a method, performed by the first wireless device 131, will now be described with reference to the flowchart depicted in FIG. 3. The method may be understood to be for handling detection of cells neighboring the first cell 121 serving the first wireless device 131. The first wireless device 131 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may be understood to be a computer-implemented method.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first wireless device 131 is depicted FIG. 3. In other examples, one or more of the actions may be performed in a different chronological order than that represented in FIG. 3. In FIG. 3, optional actions are represented with dashed boxes.

### Action 301

According to the general description provided above, embodiments herein may either rely strictly on direct, single hop, broadcast, e.g., LTE single hop broadcast, between wireless devices without support from the network node 110, e.g., an eNB, or instead use the network node 110 to provision a pool of resources for device to device communications, e.g., D2D, to the initial wireless devices, understood to be eponymous UEs. The remaining wireless devices may then be allowed to contribute anonymously, thus concealing and/or covering up their own location, but also the location of the initial wireless devices.

According to the foregoing, in this Action 301, the first wireless device 131 may receive from the network node 110 via the first cell 121, an allocation of time-frequency resources. The allocation of time-frequency resources may be for performing device to device communications for a session. The session may be identified by a unique identifier for this session, such as session ID, for the reasons indicated above, that is, to prevent wireless devices from participating in the process more than once. In some embodiments, the session may be a session indicated by another wireless device 134, that is, it may be an indicated session. This may be the case, for example, when the first wireless device 131 may receive a request broadcasted by the another wireless device 134. A session in embodiments herein may be understood as a compilation round. The first cell 121 may be understood to need to somehow identify and tag when it may have issued a request to collect data from all wireless devices. That compilation round, or session, may then receive a unique identifier which may be created on the cell side, and then passed to the first wireless device 131. The first wireless device 131 may then pass that unique identifier to the second wireless device 132, and so on. It may also be used in the case where a wireless device may receive such a broadcast twice-since each wireless device may mark the sessions it may have contributed to already, it may avoid “adding” its one or more respective measurements to a message that it may have received within the same session, twice.

The receiving in this Action 301 may be performed, e.g., via the first link 141.

Device to device communications may be understood as communications performed directly, from device to device, that is, via a single hop, without having to go via a network node, e.g., the network node 110. An example of device to device communications may be device-to-device (D2D) communications in LTE. In some embodiments, the device to device communication may be performed according to a gossip protocol. For example, gossip protocols that may compute aggregates, such as GAP, push-sum, e.g., restarted push-sum, etc. . . . Other examples of device to device communications may be used, based on technology, e.g., 5G, etc. . . .

Time-frequency resources may be understood as radio resources through which the device to device communications may be transmitted via air, and may depend on the technology used by the network node 110.

In particular examples, the first wireless device 131 and other wireless devices may be configured, according to the received allocation, for discovery of broadcast transmissions from other wireless devices to take place at a certain point in time, which may be understood to help consume less battery, instead of expecting for such broadcasts all the time.

By receiving the allocation of time-frequency resources in this Action 301, the first wireless device 131 may be enabled to rely on the network node 110 to provision resources for discovery and communication among the participating wireless devices in advance, and therefore avoid having to discover such resources on the fly. The network node 110 may provide a similar allocation of resources, e.g., in a D2D pool, to all participating wireless devices. In this case, better guarantees may be achieved that each wireless device may be able to communicate with each other at different points in time, since such resources may be preallocated, thus simplifying this process and avoiding any potential interference.

### Action 302

In embodiments herein, the first wireless device 131 may be one of the randomly picked wireless devices served by the network node 110 in the first cell 121, picked by the network node 110 to receive a request to collect measurements on cells detected by the first wireless device 131. Accordingly, in this Action 302, the first wireless device 131 may receive, from the network node 110 via the first cell 121, a request to collect measurements on cells detected by the first wireless device 131. This request may be understood to be an “original request”, also referred to herein as an “earlier request”, to distinguish from other requests. The measurements may be referred to herein as one or more respective measurements, since they may be understood to be measurements performed, on the cells detected, respectively, by the first wireless device 131.

The receiving in this Action 301 may be performed via broadcast, e.g., via the first link 141.

Any of the one or more respective measurements may be understood to be a radio measurement that may enable detection of a cell. The term “radio measurement” used herein may refer to any measurement performed on radio signals. Radio measurements may be absolute or relative. Radio measurement may be referred to as a signal level, which may be signal quality and/or signal strength. Radio measurements may be e.g., intra-frequency, inter-frequency, inter-RAT measurements, Carrier Aggregation (CA) measurements, etc. Radio measurements may be unidirectional, e.g., DL or UL, or bidirectional, e.g., Round-Trip Time (RTT), Reception-Transmission (Rx-Tx), etc. . . . Some examples of radio measurements may be: timing measurements, e.g., Time of Arrival (TOA), timing advance, RTT, Reference Signal Time Difference (RSTD), Rx-Tx, propagation delay, etc. . . . , angle measurements, e.g., angle of arrival, power-based measurements, e.g., received signal power, Reference Signal Receive Power (RSRP), received signal quality, Reference Signal Receive Quality (RSRQ), Signal to Interference Noise Ratio (SINR), Signal To Noise Ratio (SNR), interference power, total interference plus noise, Received Signal Strength Indicator (RSSI), noise power, etc. . . . , cell detection or cell identification, radio link monitoring (RLM), system information (SI) reading, etc.

The inter-frequency and inter-Radio Access Technology (RAT) measurements may be carried out by a wireless device in measurement gaps, unless the wireless device is capable of doing such measurements without gaps. Examples of measurement gaps are measurement gap id #0, e.g., each gap of 6 ms occurring every 40 ms, measurement gap id #1, e.g., each gap of 6 ms occurring every 80 ms, etc. The measurement gaps may be configured at the wireless device by the network node 110.

Performing a measurement on a carrier may imply performing measurements on signals of one or more cells operating on that carrier or performing measurements on signals of the carrier, a.k.a. carrier specific measurement, e.g., RSSI. Examples of cell specific measurements are signal strength, signal quality etc. . . .

The first wireless device 131 may also receive in this Action 302, from the network node 110 via the first cell 121, a first indication. The first indication indicates the first cell 121 served by the network node 110 that the request for one or more respective measurements originates from. The first indication may be, for example, an identifier of the first cell 121, such as e.g., CGIID, that is, a unique identifier of the first cell 121 or requesting cell.

The first wireless device 131, may further receive, in this Action 302, from the network node 110 via the first cell 121, a second indication. The second indication indicates a session to which the request belongs. The second indication may be, for example, an identifier of the session, such as e.g., sessionID, that is, a unique identifier for this session.

By receiving the earlier request from the network node 110 in this Action 302, the first wireless device 131 may be enabled to initiate the automatic collection of neighbor cell relations in the first cell 121, by the wireless devices served by the first cell 121, as will be described in the next actions. This is because by receiving the earlier request from the network node 110 in this Action 302, the first wireless device 131 may be enabled to, first, collect its own one or more respective measurements, and then request that other wireless devices within its radio range also collect their own one or more respective measurements. The first wireless device 131 may also be enabled to share the results collected by the first wireless device 131 on the detected cells, see the example in Table 1 above, with those other wireless devices within range, as will be explained in the next actions.

### Action 303

In this Action 303, the first wireless device 131 may determine, whenever a request to collect measurements on cells detected by the first wireless device 131 may be received, which request may indicate a session the request may belong to, whether a previous request has already been received for the indicated session. As mentioned earlier, this may be performed in order to avoid that a same wireless device participates in a same process more than once. Since each wireless device may broadcast a request and its respective results, which may then be summarized, it may be understood to be important to avoid asking the same wireless device twice. It may also be understood to also be important to cover as many wireless devices as possible. To avoid asking the same wireless device twice without remembering which wireless devices have already been asked, since that would break privacy, the wireless devices may be allowed to record a unique identifier for the session, e.g., the CGI session ID, that they may have received a request for, and also the point in time they may have received this request. If the wireless devices see that such a request has been received more than once, they may reject the later received request.

Determining may be understood as calculating, checking, or equivalent.

The first wireless device 131 may also determine, whenever a request to collect measurements on cells detected by the first wireless device 131 may be received, which request may indicate the session, whether the first wireless device 131 is served by a cell the previous request may have been received from. Each request may therefore comprise a unique identifier e.g., CGI ID, requesting cell ID for the requesting cell, here the first cell 121. If a wireless device is connected to another node and/or cell with a different identifier, then that wireless device may ignore this request. This may be understood to ensure that this scanning or sweeping process may remain within the coverage boundaries of the requesting cell.

The first wireless device 131 may further determine, whenever a request to collect measurements on cells detected by the first wireless device 131 may be received, which request may indicate the session, whether or not one or more conditions or criteria may be met. The criteria may be understood as a logical, e.g., Boolean, formula which may describe one or more conditions that may need to be met for the first device 131, or any of the wireless devices served by the first cell 121, to participate, aside from being served by the same cell. Those criteria may be: 1) having enough battery, expressed as, for example, battery.percentage>b), 2) being in an idle state or charging state, e.g., charging in a car during driving in a city centrum, and 3) being in a specific location, e.g., as observed via Global Positioning System (GPS) sensor of the respective wireless device. The specific location may be potentially a crowded area that may increase the chance of receiving more information. Accordingly, any wireless device may scan less if it is in suburban area. Wireless devices in certain states, e.g., idle state or charging state may not perform any measurements, but instead just broadcast the request to other wireless devices, without adding any measurements to it.

According to the foregoing, the one or more conditions may comprise at least one of: a battery level of the first wireless device 131, a state of the first wireless device 131 and a location of the wireless device 131.

The first wireless device 131 may further determine, whenever a request to collect measurements on cells detected by the first wireless device 131 may be received, which request may indicate a session, whether or not a map of physical cell global identifiers is comprised for the identified session that has been received. The first cell 121 may have shared a mapping of the Physical Cell Identifiers (PCIs) to CGIs (Cell Global Identifier) that it may already know. In such a case, the first wireless device 131, as any other wireless device served by the first cell 121, may not need to request the CGI for known PCIs, but may instead deliver the PCI ID only, thus simplify the process. The map may be comprised in the received request, or it may have been shared at an earlier stage by the network node 110, and then locally stored by the first wireless device 131. Physical Cell Identifiers may be understood to not be unique. Therefore, if the first cell 121 does not know the CGI of the PCI, it may need to retrieve it. This task may be offloaded as well and instead be assigned to the participating wireless devices, e.g., the first wireless device 131.

According to the foregoing description, Action 303 may be performed iteratively, whenever a request may be received by the first wireless device 131.

In a first iteration, the first wireless device 131 may determine, in this Action 303, based on the received earlier request, at least one of the following. According to a first option, the first wireless device 131 may determine whether a previous request has already been received for the indicated session. According to a second option, the first wireless device 131 may determine whether the first wireless device 131 is served by the first cell 121. According to a third option, the first wireless device 131 may determine whether or not the one or more conditions are met. According to a fourth option, the first wireless device 131 may determine whether or not the map of physical cell global identifiers is comprised for the identified session has been received.

Similarly, in another iteration of this Action 303, the first wireless device 131 may determine, based on another received request, e.g., a received first request, which will be described later, at least one of a) whether a previous first request has already been received for the indicated session, b) whether the first wireless device 131 is served by the first cell 121, c) whether or not one or more conditions are met; wherein the one or more conditions may comprise at least one of: the battery level of the first wireless device 131, the state of the first wireless device 131 and the location of the wireless device 131, and d) whether or not the map of physical cell global identifiers is comprised for the identified session in the first request that has been received.

By determining at least one of a-iv in this Action 303, the first wireless device 131 may be enabled to know if it should proceed with the collection of the one or more respective measurements, as requested, e.g., if the first wireless device 131 is served by the first cell 121, or not, for example, if any of: a) a previous first request has already been received for the indicated session, b) the first wireless device 131 was not served by the first cell 121, c) the first wireless device 131 had very little battery left or was charging, and whether the first wireless device 131 may have changed location. The first wireless device 131 may tag its location so that the next time it may be asked to collect measurements, it may contribute only if it may have moved to a new location, even within the same session. Hence, performance of Action 303 may ensure that the first wireless device 131 may assist the network node 110 in gathering information on the neighboring cells, as comprehensively as possible, without risking that performance of the first wireless device 131 is compromised, by e.g., depleting its battery, or by adding redundant measurements.

### Action 304

In this Action 304, the first wireless device 131 may collect, based on a result of the determination of at least one of i-iv in Action 303 obtained for a respective iteration, and further based on the received request in every iteration, the one or more respective measurements on the cells detected by the first wireless device 131.

For example, in one particular iteration, represented in FIG. 3 by the thin, down pointing arrows linking Actions 303-306, the first wireless device 131 may collect in this Action 304, based on a result of the determination of at least one of i-iv in Action 303 obtained in the first iteration, and further based on the received earlier request, the one or more respective measurements on the cells detected by the first wireless device 131. To collect the one or more respective measurements may be understood as to perform the one or more respective measurements, and store, in a respective matrix or table, e.g., such as that shown in Table 1 above, the measurements detected above the threshold.

In another iteration, represented in FIG. 3 by the thin, down pointing arrows linking Actions 306-307, the up pointing arrow linking Action 307 to Action 303 and the thick down pointing arrows linking Actions 303-311 until the end, the first wireless device 131 may collect in this Action 304, based on a result of the determination of at least one of i-iv in Action 303 obtained in the another iteration, and further based on the received first request, which will be described in Action 307, the one or more respective measurements on the cells detected by the first wireless device 131.

By, in this Action 304, collecting the one or more respective measurements on the cells detected by the first wireless device 131 based on the result of the determination of at least one of i-iv in Action 303, and further based on the received first request, the first wireless device 131 may gather information on the neighboring cells to the first cell 121 and thereby assist the network node 110 in obtaining that information, without risking that performance of the first wireless device 131 is compromised, by e.g., depleting its battery.

### Action 305

In order to avoid that the method endlessly iterates, and at the same time, ensure that the respective measurements of as many different wireless devices served by the first cell 121 as possible are collected on neighboring cells, in this Action 305, the first wireless device 131 may determine, after collecting the one or more respective measurements, whether or not a maximum number of wireless devices may have been reached. This maximum number may be the certain margin m described earlier. The maximum number may be required to be smaller or equal to the number of active RRC connections in the requesting cell, here the first cell 121, in the worst case scenario.

If the maximum number of wireless devices has been reached, the first wireless device 131 may send a further indication to the network node 110 indicating the collected one or more respective measurements on cells detected by at least the first wireless device 131 in the absence of sending the respective identity the first wireless device 131 to the network node 110.

### Action 306

If the maximum number of wireless devices has not been reached, the first wireless device 131, may continue the gathering of respective measurements on neighbor cells to the first cell 121 by forwarding the received request or sending a new request equivalent to it, to another wireless device within its radio range. Accordingly, in this Action 306, the first wireless device 131 may send, to at least the third wireless device 133 operating in the wireless communications network 100, via device to device communication, a further request to collect one or more respective measurements on cells detected by the third wireless device 133. The first wireless device 131 may also send, to at least the third wireless device 133, via device to device communication, the first indication indicating the first cell 121 the further request for the one or more respective measurements originates from. As mentioned earlier, it is the network node 110 that the earlier request or original request originates from, but since the earlier request is in relation to and send via the first cell 121, it may be stated expressed as that the further request originates from the first cell 121.

The sending in this Action 306 may be performed via broadcast, e.g., via the sixth link 146.

The first wireless device 131 may further send, to at least the third wireless device 133, via device to device communication, the second indication indicating the session to which the further request belongs. This may enable that the first wireless device 131 refrain from providing its identity to the third wireless device 133 when performing this Action 306, thereby enabling the first wireless device 131 to preserve its privacy.

The sending in Action 306 of the further request may be based on the received earlier request. That is, while the further request may be sent to the third wireless device 133 and, in that sense, be different from the earlier request, which may have been received from the network node 110, the further request may be understood to have been triggered originally by the earlier request, and may comprise the same first indication and the same second indication, as originally indicated in the earlier request.

By sending the further request in this Action 306, the first wireless device 131 may ensure that the respective measurements of as many different wireless devices served by the first cell 121 as possible are collected on neighboring cells, so that the network node 110 may ultimately obtain a report on all detected neighboring cells, which may be as complete as possible. That is, after the first wireless device 131 may have collected its respective one or more measurements, the first wireless device 131 may propagate, via device to device communication, the request to other wireless devices within its radio range, so that the request may reach as many different wireless devices as possible.

### Action 307

In the meantime, other wireless devices may have received a similar request, either directly from the network node 110, from another network node, or from yet other wireless devices. The other wireless devices may also propagate the request to the respective wireless devices in their respective radio coverage. Accordingly, in this Action 307, the first wireless device 131 receives, from another wireless device, e.g., the fourth wireless device 134, operating in the wireless communications network 100, via device to device communication, a request to collect one or more respective measurements on cells detected by the first wireless device 131. This request is referred to herein as the “first request”, to distinguish it from the “earlier request”, any “previous request”, and the “further request” already mentioned. The first wireless device 131 also receives, from the another wireless device 134, via device to device communication the first indication indicating the first cell 121 served by the network node 110 that the request for the one or more respective measurements originates from. The first wireless device 131 further receives, from the another wireless device 134, via device to device communication, the second indication indicating a session to which the request belongs.

The receiving in this Action 307 may be performed, via broadcast, e.g., via the seventh link 147.

It may be understood that, in some embodiments, the first indication and the second indication may be comprised in the first request.

The first request may further comprise an indication for the threshold t above which a detected measurement may be considered intense enough to be recorded as a detection by the first wireless device 131.

By the first wireless device 131 receiving the first request in this Action 307, the first wireless device 131 may be enabled to gather information on the neighboring cells to the first cell 121 and thereby assist the network node 110 in obtaining that information. This may be understood in turn to enable that the requesting network node 110 and/or cell may be offloaded from having to itself query each wireless device that may have an active connection with it, in order to get such information. Instead, the process may be delegated to the different wireless devices served by the first cell 121, and the network node 110, via the first cell 121, may only receive the final result. The offloading here may be understood to represent less energy consumption for the network node 110, less signalling, and smaller computation cost. To achieve the same benefits on the wireless device side, wireless devices may check how much battery they have at their disposal, or the computational resources, and opt-in/opt-out accordingly.

By the first wireless device 131 receiving the first indication in this Action 307, it may be ensured that this scanning or sweeping process may remain within the coverage boundaries of the requesting cell. If the first indication were not to indicate the first cell 121 serving the first wireless device 131, then the first wireless device 131 would be able to ignore this request.

By the first wireless device 131 receiving the second indication in this Action 307, it may be ensured that as many wireless devices as possible are requested to perform the respective measurements while also avoiding asking the same wireless device twice. Further, this may be ensured without having to remember which wireless devices have already been asked, since that would break privacy. The wireless devices may be allowed to record the second indication that they may have received a request for, and also the point in time they may have received the request. If the first wireless device 131 were to see that the first request has been received more than once, it may reject the new first request.

This process may continue in order to cover every available wireless device that may be connected to the first cell 121, e.g., identified by CGI1, which in this case may be understood to be the identifier of the requesting cell that initiated this request. Since each wireless device may broadcast this information which may then be summarized, it may be understood to be important to avoid asking the same wireless device twice.

The another wireless device 134 may have refrained from providing its identity to the first wireless device 131 when sending the first request received in this this Action 307. This may provide the further advantage that the wireless devices served by the first cell 121 may be enabled to automatically gather information in a cell about neighboring cells, while maintaining their privacy. The first cell 121 may ultimately receive a summary of the cells, as identified by e.g., CGIs, that each wireless device may have listened to, without knowing which wireless device may have listened to which cells, as identified by e.g., CGI, specifically. The wireless devices that participate may be understood to not know the identity of the other wireless devices either, since that information is not communicated-both parties, the network node 110 and the wireless devices, may be assumed to be distrusting.

### Action 308

The first wireless device 131 may continue to propagate the request to other wireless devices in its respective radio coverage. In order to do that, in this Action 308, the first wireless device 131 may first send, via device to device communication, to at least the second wireless device 132, a fourth indication. The fourth indication may indicate a type of application supported by the first wireless device 131 to support automatically handling neighbor relations. The first wireless device 131 may broadcast only the type of the application and not the identity of the first wireless device 131. The fourth indication may be e.g., an “application_type=“anr” to indicate that the first wireless device 131 may be participating in a process that may be endorsed by the operator.

The sending in this Action 308 may be performed via broadcast, e.g., via the fifth link 145.

The first wireless device 131 may refrain from providing its identity to the second wireless device 132, that is, when performing this Action 308.

By sending the fourth indication in this Action 308 to the second wireless device 132, the first wireless device 131 may state the purpose of the discovery request. Knowing that, the second wireless device 132 may decide if it may contribute or not to this anonymous request, but still annotated by its purpose.

### Action 309

In this Action 309, the first wireless device 131 may receive, based on the sent fourth indication and via device to device communication, a first connection request from the second wireless device 132.

The receiving in this Action 309 may be performed, e.g., via the fifth link 145.

By receiving the first connection request in this Action 309 from the second wireless device 132, since this may be a part of the established device to device communication, this may indicate that the frequency that may be being used may be already cleared from the device to device pool of known allocations of the network node 100.

### Action 310

In this Action 310, the first wireless device 131 sends, to at least the second wireless device 132 operating in the wireless communications network 100, via device to device communication, a second request to collect one or more respective measurements on cells detected by the second wireless device 132.

The sending in this Action 310 may be performed via broadcast, e.g., via the fifth link 145.

In some embodiments, the sending in Action 310 of the request to the second wireless device 132 may be based on the received first connection request in Action 309. That is, the first wireless device 131 may only send the second request with the proviso that the first wireless device 131 has received the first connection request from the second wireless device 132.

The first wireless device 131 may also send, to at least the second wireless device 132, via device to device communication the first indication indicating the first cell 121 served by the network node 110 that the request for the one or more respective measurements originates from. The advantage of sending the first indication may be understood to be as explained earlier.

The first wireless device 131 may also send, to at least the second wireless device 132, via device to device communication, the second indication indicating the session to which the request belongs. The advantage of sending the second indication may be understood to be as explained earlier.

In some examples, the second request sent to at least the second wireless device 132 may comprise a third indication. The third indication may indicate the collected one or more respective measurements on the cells detected by the first wireless device 131 in Action 304. The third indication may be, or may comprise, for example, Table 1 shown above.

In some embodiments, the first wireless device 131 may determine, in Action 305, whether or not the maximum number of wireless devices has been reached, after collecting the one or more respective measurements, and prior to sending, in this Action 310, the second request to the second wireless device 132.

The first wireless device 131 may refrain from providing its identity to the second wireless device 132, that is, when performing this Action 310. This may enable it to preserve its privacy.

In some embodiments, in Action 305, the first wireless device 131 may have determined, after collecting the one or more respective measurements whether or not the maximum number of wireless devices may have been reached, prior to sending 310 the second request to the second wireless device 132. In some of these embodiments, the sending in Action 310 of the second request may be performed with the proviso that the maximum number of wireless devices has not been reached.

The second request may further comprise the indication for the threshold t, which may be used by the second wireless device 132.

By sending the second request in this Action 310, the first wireless device 131 may ensure that the respective measurements of as many different wireless devices served by the first cell 121 as possible are collected on neighboring cells, so that the network node 110 may ultimately obtain a report on all detected neighboring cells, which may be as complete as possible. That is, after the first wireless device 131 may have collected its one or more respective measurements, the first wireless device 131 may propagate, via device to device communication, the request to other wireless devices within its radio range, so that the request may reach as many different wireless devices as possible.

Moreover, by sending the third indication, the first wireless device 131 may enable the cumulative aggregation of the one or more respective measurements from the different wireless devices served by the first cell 121, so it may be ultimately provided to the network node 110 as a single summary.

### Action 311

In this Action 311, the first wireless device 131 may receive, via device to device communication and after sending the second request in Action 310, from at least the second wireless device 132, a fifth indication. The fifth indication may indicate to tear down the device to device communication for the indicated session with the second wireless device 132.

The receiving in this Action 311 may be performed via broadcast, e.g., via the fifth link 145.

By receiving the fifth indication in this Action 311 from the second wireless device 132, the first wireless device 131 may be enabled to cover larger ground, that is, as many wireless devices as possible, given the broadcasting capability of each wireless device, since tearing down the communication may be understood to release resources on the device to device communication, or sidelink.

The method performed by the first wireless device 131 may be understood to enable to automatically discover or detect neighbor relations to the first cell 121.

Embodiments of a method, performed by the second wireless device 132, will now be described with reference to the flowchart depicted in FIG. 4. The method may be understood to be for handling detection of cells neighboring the first cell 121 serving the second network node 132. The second wireless device 132 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may be understood to be a computer-implemented method.

Several embodiments are comprised herein. In some embodiments all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second wireless device 132 is depicted FIG. 4. In other examples, one or more of the actions may be performed in a different chronological order than that represented in FIG. 4. In FIG. 4, optional actions are represented with dashed boxes. The detailed description of some of the following corresponds to the same references provided above, in relation to the actions described for the first wireless device 131, and will thus not be repeated here to simplify the description. For example, the first indication may be, e.g., a CGI ID.

### Action 401

In this Action 401, the second wireless device 132 may receive from the network node 110 via the first cell 121, the allocation of time-frequency resources. The allocation of time-frequency resources may be for performing device to device communications for the session. In some embodiments, the session may be a session indicated by the first wireless device 131, that is, it may be the indicated session. This may be the case, for example, when the second wireless device 132 may receive the second request broadcasted by the first wireless device 131.

The receiving in this Action 401 may be performed, e.g., via the second link 142.

In some embodiments, the device to device communication may be performed according to a gossip protocol, such as GAP, push-sum e.g., restarted push-sum, etc. . . . Other examples of device to device communications may be used, based on technology, e.g., 5G, etc. . . .

### Action 402

In this Action 402, the second wireless device 132 may receive, via device to device communication, from the first wireless device 131, the fourth indication indicating the type of application supported by the first wireless device 131 to support automatically handling neighbor relations.

The first wireless device 131, when this Action 402 may be performed, may refrain from providing its identity to the second wireless device 132.

This Action 402 may be performed with the proviso that the maximum number of wireless devices has not been reached.

The receiving in this Action 402 may be performed via broadcast, e.g., via the fifth link 145.

### Action 403

In this Action 403, the second wireless device 132 may send, based on the received fourth indication and via device to device communication, the first connection request to the first wireless device 131.

This Action 403 may be performed with the proviso that the maximum number of wireless devices has not been reached.

The sending in this Action 403 may be performed via broadcast, e.g., via the fifth link 145.

The second wireless device 132 may refrain from providing its identity to the first wireless device 131, that is, when performing this Action 403. This may enable it to preserve its privacy.

### Action 404

In this Action 404, the second wireless device 132 receives, from at least one first wireless device, that is, the first wireless device 131, operating in the wireless communications network 100, via device to device communication, a) the second request to collect one or more respective measurements on cells detected by the second wireless device 132, b) the first indication indicates the first cell 121 served by the network node 110 that the request for the one or more measurements originates from, c) the second indication indicates the session to which the request belongs, and d) the third indication indicates the one or more respective measurements on the cells detected by the first wireless device 131.

The receiving in this Action 404 of the second request from the first wireless device 131 may be based on the sent first connection request in Action 403.

The first wireless device 131, when this Action 404 may be performed, may refrain from providing its identity to the second wireless device 132.

The receiving in this Action 404 may be performed via broadcast, e.g., via the fifth link 145.

The second wireless device 132 may receive a plurality of respective requests from a plurality of first wireless devices 130. Each of the respective requests may comprise the respective one or more measurements collected by the respective first wireless devices in the plurality of first wireless devices 130.

### Action 405

In this Action 405, the second wireless device 132 may determine, based on the received second request, at least one of a) whether a previous first request has already been received for the indicated session, b) whether the second wireless device 132 is served by the first cell 121, c) whether or not one or more conditions are met; wherein the one or more conditions may comprise at least one of: the battery level of the second wireless device 132, the state of the second wireless device 132 and the location of the second wireless device 132, and d) whether or not the map of physical cell global identifiers is comprised for the identified session in the second request that has been received.

### Action 406

In this Action 406, the second wireless device 132 collects, based on the received second request, the one or more respective measurements on cells detected by the second wireless device 132.

### Action 407

In this Action 407, the second wireless device 132 may determine, after collecting the one or more respective measurements, whether or not the maximum number of wireless devices has been reached.

### Action 408

In this Action 408, the second wireless device 132 sends, to the network node 110 operating in the wireless communications network 100, the network node 110 serving the first cell 121, a further indication. The further indication indicates the collected one or more respective measurements on the cells detected by the second wireless device 132 and the one or more respective measurements on the cells detected by the at least one first wireless device 131.

The further indication may comprise, for example a Table such as that depicted in Table 3 above. The further indication may indicate a summary process, which may be understood to be the sum of two hashtables and, as such, it may be obtained by summing, e.g., numerically adding, the contents of each key with a corresponding key that may be created locally when any participating wireless device may measure for signal strength. If the key is missing, then zero may be added, and an entry may be created for it in the final result, that is, as in key4 and key8 in the example bellow.
HashTable 1 {“key1”: val1, “key2”: val2, “key4”: val3}
HashTable 2 {“key2”: val4, “key1”: val5, “key8”: val6}
HashTable 1+2 {“key1”: val+val5, “key2” val2+val4, “key4”: val3, “key8”: val6} The sending in this Action 409 may be performed, e.g., via the second link 142.

In some embodiments, the sending in this Action 408 of the further indication may be performed with the proviso that the maximum number of wireless devices has been reached.

In some embodiments, the second wireless device 132 may have received the plurality of respective requests from the plurality of first wireless devices 130. Each of the respective requests may comprise the respective one or more measurements collected by the respective first wireless devices in the plurality of first wireless devices 130. In some of such embodiments, the sent further request may comprise a compilation of all received respective one or more measurements, with the proviso that of measurements performed on a same cell, in the examples herein, the first cell 121, only a most recent measurement may be included in the sent further request.

The second wireless device 132 may refrain from providing its identity to the network node 110, that is, when performing this Action 408. This may enable it to preserve its privacy.

### Action 409

In this Action 409, the second wireless device 132 may send, via device to device communication and after receiving the second request in Action 402, to the first wireless device 131, the fifth indication. The fifth indication may indicate to tear down the device to device communication for the indicated session with the first wireless device 131.

The sending in this Action 409 may be performed, e.g., via the fifth link 145.

The second wireless device 132 may refrain from providing its identity to the first wireless device 131, that is, when performing this Action 409. This may enable it to preserve its privacy.

The methods respectively performed by the second wireless device 132 and by the first wireless device 131, may be understood to enable to automatically discover or detect neighbor relations to the first cell 121.

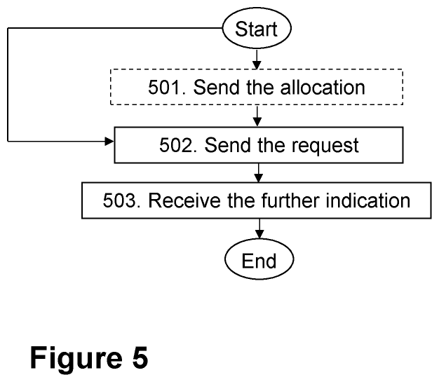

Embodiments of a method performed by the network node 110 serving the first cell 121, will now be described with reference to the flowchart depicted in FIG. 5. The method may be understood to be handling detection of cells neighboring the first cell 121. The network node 110 operates in the wireless communications network 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may be understood to be a computer-implemented method.

The method may comprise two or more of the following actions. Several embodiments are comprised herein. In some embodiments all the actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the network node 110 is depicted FIG. 5. Some actions may be performed in a different order than that shown in FIG. 5. In FIG. 5, optional actions are represented with dashed lines. The detailed description of some of the following corresponds to the same references provided above, in relation to the actions described for the first wireless device 131, and will thus not be repeated here to simplify the description. For example, the first indication may be, e.g., a CGI ID.

### Action 501

In this Action 501, the network node 110 may send, to at least one of a wireless device, e.g., the first wireless device 131 and/or the third wireless device 133, and a different wireless device, e.g., any of the second wireless device 132 and the another wireless device 134, the allocation of time-frequency resources for performing device to device communications for the indicated session. The allocation may be the same or a respective allocation to each of the wireless devices. The respective allocations may differ depending on availability, for example, if they may have been allocated before. In some examples, there may be a “default” allocation reserved for the sole purpose of this compilation.

The sending in this Action 501 may be performed, via broadcast, e.g., via any of the first link 141, the second link 142, the third link 143 and the fourth link 144.

### Action 502

In this Action 502, the network node 110 sends, to at least the wireless device operating in the wireless communications network 100, e.g., the first wireless device 131 and/or the third wireless device 133, a) the request, that is the “earlier request”, to collect one or more respective measurements on cells detected by the wireless device operating in the wireless communications network 100, e.g., the first wireless device 131 and/or the third wireless device 133, b) the first indication indicates the first cell 121, and c) the second indication indicates the session to which the first request belongs.

The sending in this Action 501 may be performed, via broadcast, e.g., via the first link 141 and/or the third link 143.

### Action 503

In this Action 503, the network node 110 receives, from a different wireless device 132, the further indication indicating the collected one or more respective measurements on cells detected by at least the wireless device operating in the wireless communications network 100, e.g., the first wireless device 131 and/or the third wireless device 133, and the different wireless device 132. The receiving in this Action 503 is performed in the absence of receiving a respective identity of the wireless device operating in the wireless communications network 100, e.g., the first wireless device 131 and/or the third wireless device 133, and the different wireless device 132.

The further indication may be e.g., Table 3 described above.

The receiving in this Action 503 may be performed, e.g., via any of the first link 141, the second link 142, the third link 143 and the fourth link 144.

The method performed by the network node 110 may be understood to enable to automatically discover or detect neighbor relations to the first cell 121.

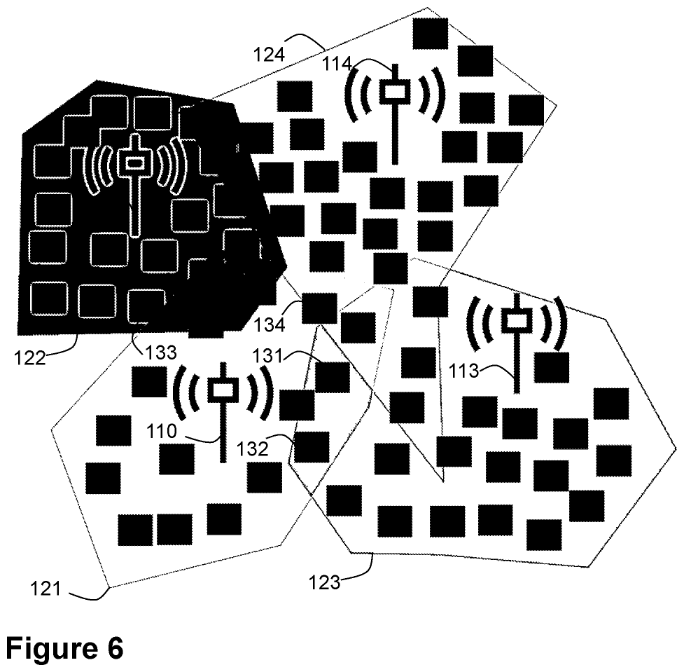

FIG. 6 is a schematic diagram depicting a non-limiting example of a scenario according to embodiments herein. In this depicted non-limiting example, the network node 110 is depicted serving the first cell 121. The first cell 121 serves, among other wireless devices, the first wireless device 131, the second wireless device 132, the third wireless device 133 and the another wireless device 134. The first cell 121 has three neighboring cells, the second cell 122, the third cell 123, and the fourth cell 124, each serving a respective plurality of wireless devices, each represented as a rectangle. Each of the second cell 122, the third cell 123, and the fourth cell 124 is served by a respective network node, that is, the second network node 112, the third network node 113 and the fourth network node 114, respectively. The respective coverage of the first cell 121 overlaps with that of the second cell 122, the third cell 123, and the fourth cell 124, hence any of the first wireless device 131, the second wireless device 132, the third wireless device 133 and the another wireless device 134 may detect at least some of the neighboring cells. Of the multiple wireless devices depicted, each wireless device is served or attached, that is, it exists within the coverage, to one cell, its primary serving cell. According to embodiments herein, the network node wanting to obtain neighbor relations, in examples herein, the network node 110, may choose one such wireless device randomly, in examples herein, the first wireless device 131, and then, that wireless device, by way of making broadcasts, find the next wireless device or wireless devices within the same coverage area, and start adding measurements for the different eNB/cells that they may respectively receive or detect. Eventually, by broadcasting among the wireless devices within range, the entire space may be scanned in parallel and an accurate table for all the cells that may be related to the cell that initiated this process, in embodiments herein, the first cell 121, may be collected by the network node 110. The method performed by the first wireless device 131, the second wireless device 132 and the network node 110 may be understood to enable to automatically discover or detect neighbor relations to the first cell 121.

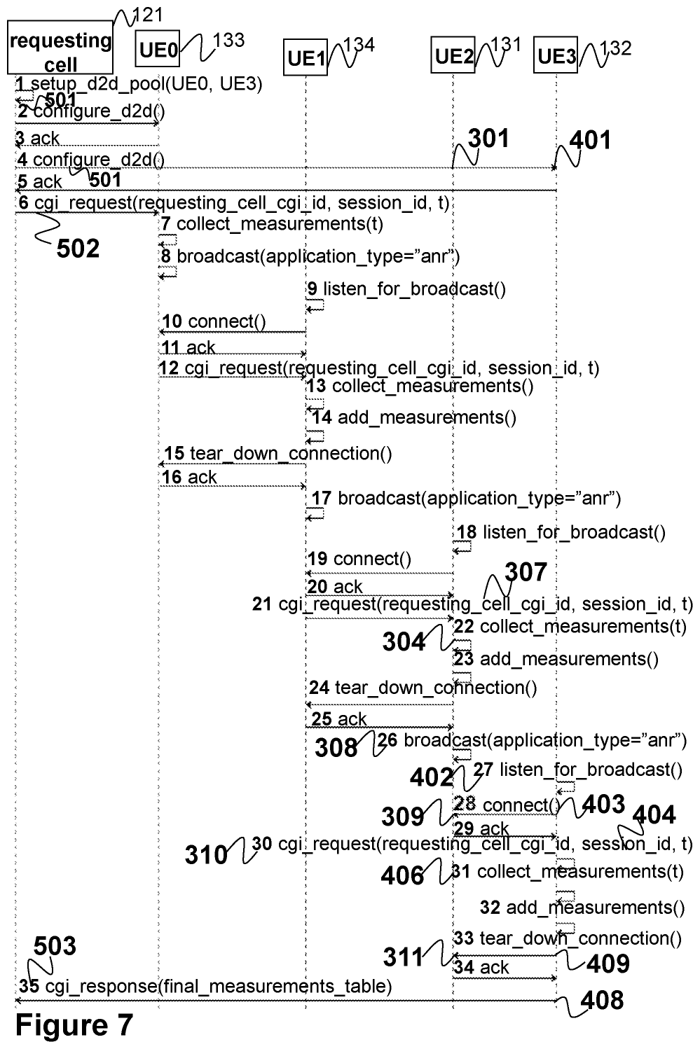

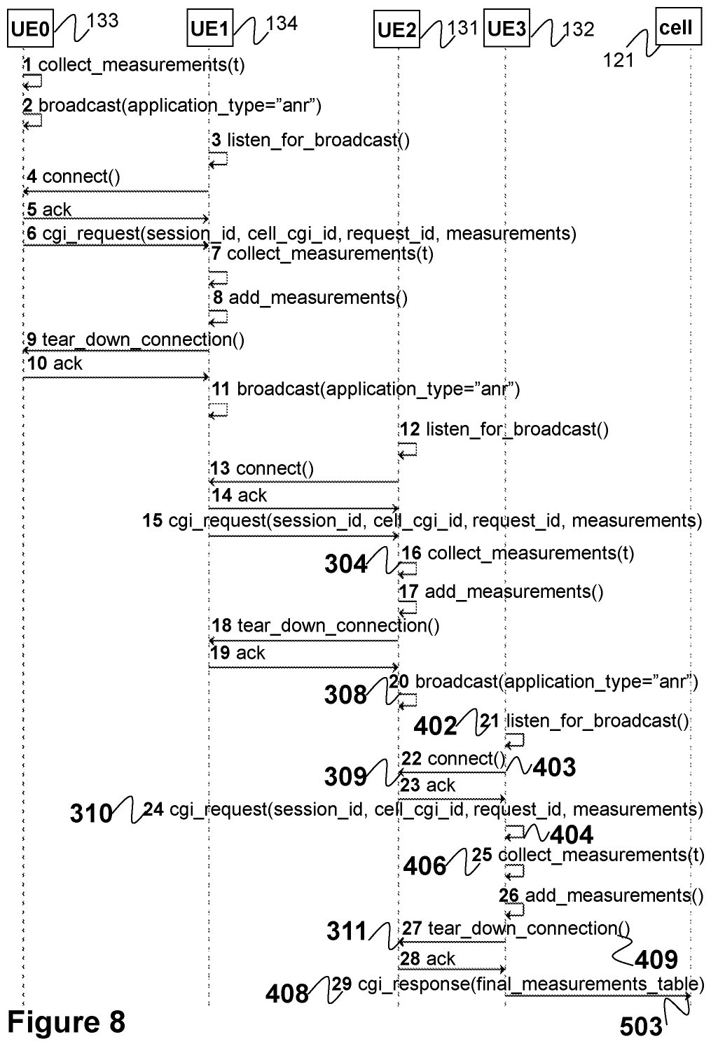

The methods just described in relation to FIG. 3, FIG. 4 and FIG. 5 will now be illustrated with some non-limiting examples. Two groups of examples may be considered herein. In a first group of examples, the privacy of the majority of the participating wireless devices, except for those that may be allocated using a D2D pool, and also of their location may be preserved. A particular non-limiting example according to a first group of examples is illustrated in the signalling diagram of FIG. 7. In a second group of examples, the privacy of all wireless devices, and also of their location may be preserved. A particular non-limiting example according to a first group of examples is illustrated in the signalling diagram of FIG. 8. The first approach may be considered to be more advantageous in the case of establishing D2D connection, since it may be understood to rely on the network node 110 to provision such resources in advance, while in the second case, such resources may be understood to need to be discovered on the fly. Each of FIG. 7 and FIG. 8 is described next.

FIG. 7 is a signalling diagram depicting a non-limiting example according to the first group of examples, showing a privacy-aware discovery and construction of a cumulative NRT table initiated by the network node 110 via the first cell 121, represented as the requesting cell, using D2D pool for some wireless devices, e.g., eponymous, but not for others, e.g., anonymous, according to embodiments herein. In this example, the wireless devices are UEs. The first node 131 is represented as UE2, the second node 132 is represented as UE3, the third wireless device 133 is represented as UE0 and the another wireless device 134 is represented as UE1. In step 1, the network node 110, which has an awareness of available D2D resources, may be setup, e.g., by an Operations, Administration and Maintenance (OAM) node, to provision and allocate those resources via the first cell 121, that is, the requesting cell, to only two of the participating wireless devices, UE0 and UE3. These wireless devices may have guaranteed access to communication channels at the expense of revealing their identity to the requesting_cell. In step 2, the D2D allocation, in accordance to Action 501, is communicated to UE0. In the first group of examples, step 1 may be used to allocate resources in the D2D pool for all participating UEs. In this case, better guarantees may be achieved that each UE may be able to communicate with each other at different points in time, since such resources may be preallocated, thus simplifying this process and avoiding any potential interference. In step 3, UE0 acknowledges this allocation. Here, a positive scenario is assumed, where this is settled without the need for renegotiation. In step 4, the D2D allocation is communicated to UE3, in accordance to Action 501. In step 5, UE 3 acknowledges this allocation. In step 6, the requesting_cell, in accordance to Action 502, initiates the process which constructs the NRT table by accumulating, e.g., summing, information from the participating wireless devices, UE0, UE1, UE2, UE3. The request is tagged with the first indication, here, the requesting cell CGI ID. This information is used to coordinate the process as it propagates throughout the different wireless devices. In addition, the second indication, here, a session ID, is provided in order to identify this session and prevent wireless devices from participating in the process more than once. In each step, such as step 7, each UE may collect measurements for the signal strength for each node in its vicinity, as indicated by “collect_measurements”. Threshold t may be used to determine which signal strength values may be considered appropriate for this process. In step 8, once measurements may have been collected, UE0 broadcasts that it may receive LTE direct D2D connections. As opposed to what may be stated in a standard, in this case, UE0 may broadcast only the type of the application, and not the identity of the UE. In the context of this exchange, and as stated in the sequence diagram, the type of application is set to “anr”, to indicate that the UEs are participating in a process that is endorsed by the operator. In step 9, UE1 listens for such broadcasts and, once it receives it, it may respond to UE0 with a connection request. In step 10, UE1 sends a connection request to UE0. In step 11, UE0 acknowledges the connection. In step 12, UE0 asks UE1 to participate in the process of building the NRT table by providing its own measurements and also the CGI id of the requesting_cell. In this scenario, it is assumed that UE1 is also connected to the same requesting_cell. If that is not the case, UE1 may be understood to reject this request. In step 13, UE1 collects measurements about the nodes it can listen to. In step 14, UE1 adds this information to the one that it received from UE0. In step 15, UE1 tears down its connection with UE0. In step 16, UE0 acknowledges that the connection is terminated. Steps 8-16 are then repeated, in steps 17-25 for UE2, and in steps 26-34 for UE3, thereafter until UE3 is reached. In Step 21, the first wireless device 131 may receive the first request in accordance to Action 307. The first request, a cgi_request, comprises the first indication as a cell_cgi_id, and the second indication, as the session_id. The first request may further comprise an indication for the threshold t above which a detected measurement may be considered intense enough to be recorded as a detection by the first wireless device 131. In Step 22, the first wireless device 131 may collect the one or more respective measurements in accordance to Action 304. In Step 26, the first wireless device 131 may send the fourth indication in accordance to Action 308. In Step 27, the second wireless device 132 may listen to broadcast and receive the fourth indication in accordance to Action 403. In Step 28, the second wireless device 132 may send the first connection request to the first wireless device 131, in accordance to Action 403, and the first wireless device 131 may receive the first connection request in accordance to Action 309. In Step 30, the first wireless device 131 may send the second request in accordance to Action 310. The second request comprises the first indication, the second indication and the threshold t. In Step 31, the second wireless device 132 may collect one or more respective measurements in accordance to Action 406. In Step 33, the second wireless device 132 may send the fifth indication to the first wireless device 131 in accordance to Action 409, and the first wireless device 131 may receive it in accordance to Action 311. In step 35, the second wireless device 132 determines that enough information has been collected and therefore it sends, in accordance to Action 408, a cgi_response, which contains all accumulated information back to the requesting_cell, as a final_measurements:table. The network node 110 receives the further indication, in accordance to Action 503.

FIG. 8 is a signalling diagram depicting a non-limiting example according to the second group of examples, showing a privacy-aware discovery and construction of a cumulative NRT table initiated by a wireless device using direct LTE without D2D pool. In such second group of examples, the process may not need to be initiated by the first cell 121, but instead it may be initiated by any wireless device, based on different criteria, such as the time of the day, or the state of the wireless device, for example, whether or not the wireless device may be idle, or if it may have enough computational capacity, battery etc. In this case, the first indication, e.g., the requesting CGI ID, may then be the cell ID where the wireless device may be attached to and, as such, it may be that cell that receives the result of this process. In the example of FIG. 8, the wireless devices are UEs. The first node 131 is represented as UE2, the second node 132 is represented as UE3, the third wireless device 133 is represented as UE0 and the another wireless device 134 may be represented as UE1. The other steps may be understood to have an equivalent description to those depicted in FIG. 7.

In a third group of examples, initiated by a cell, that is, by the network node 110 serving that cell via that cell, the cell may share the mapping of the Physical Cell Identifiers (PCIs) to Cell Global Identifier (CGIs) that it may already know. In such a case, each wireless device may be understood to not need to request the CGI for known PCIs, but instead deliver the PCI id only, thus simplifying the process.

### Example

As a non-limiting example, the following algorithm describes the scanning/sweeping process in greater detail, wherein the wireless devices are UEs:

The parameters used may be:
Peers: which may be understood to indicate a list of peers as produced by D2D discovery;
sessionID: which may be understood as a unique identifier for this session
CGIID: which may be understood as the unique identifier of the requesting cell
m: which may be understood to indicate the one or more respective measurements for neighboring cells as produced by reference signals transmitted by each UE. In this case, this may be converted to an array as described previously, which may contain a 1 for each node for which the UE has a good reference signal;
last_update: which may be understood to indicate the last update a given UE may have pushed, to determine if new information has been received or not
FAN_IN: which may be understood to control the number of the messages that may be being received by each UE
FAN_OUT: which may be understood to control the number of messages that may be being broadcasted at each step of the process;
MAX: which may be understood to indicate the maximum number of UEs with active RRC connections in the cell, e.g., the first cell 121;

| | |
|---|---|
| procedure | do forever |
| broadcast_measurements(m) | CR <− waitForCGIRequest(FAN_IN) |
| peers <− discover(FAN_OUT) | if criteria is True and CR.CGIID == CGIID |
| for p in peers do in parallel: | // the request is coming from a device that is connected |
| c <− connect(p) | to the same cell and if enough battery |
| c.cgi_request(sessionID, | if (CR.sessionId not in session) |
| m, CGIID) | // this is the first request for this session |
| c.close( ) | sessions <+ CR.sessionID |
| | // append sessionID |
| | m <− measure_neighbouring_cells( ) |
| | m′ <− CR.m + m |
| | last_update <− m′ |
| | CR.m <− m′ |
| | if (m[CGI_ID] > MAX) |
| | // if we have reviewed all UEs in the same cell |
| | send(m′, CGIID) |
| | else |
| | // we propagate this message further |
| | broadcast_measurements(CR) |
| | else: |
| | if (m′[CGID] > last_update[CGIID]) |
| | // the information has been updated by more UEs than |
| | the last update including this UE |
| Requesting Thread | last_update <− m |
| | broadcast_measurements(CR) |
| | Receiving Thread |

The example algorithm is split into two different processes or threads, where each thread is run on a different device. The Requesting Thread, shown on the left, is meant to run on the initial UE which is selected to start this process while the Receiving Thread may be understood to be run on all other UEs that participate.

The Requesting Thread is designed to discover peers using LTE D2D discovery and initiate CGI requests which contain a unique session identifier, a hash table m which contains the neighboring cells, and the requesting cell's CGI ID. The discovery process is bounded by FAN_OUT, which allows to limit the amount of peers to be discovered.

The Receiving Thread is constantly waiting for such messages. This process is bounded by FAN_IN, which allows to control how many broadcasts may be desired to be received. However, it is selective. Since summaries are created here and since it is possible that a UE that has received this message may receive it again, it may be first checked if the UE is connected to the same cell as the one that has initiated the request. Then it may be checked if the UE has received this message before, and if it has not, then measurements may be collected. These measurements may be added to the measurements received previously and then it may be checked if all UEs have been covered, as noted by the active RRC connections. This constant variable MAX may be set to a lower threshold in order to limit this process, if that may be needed, or, if it is too expensive to perform a holistic search. If that is the case, the summary may then be communicated back to the requesting cell. If not, then the code from the Requesting Thread may be re-used to propagate this message further to the remaining peers. If the UE receives an updated message which also includes its own updates, but it has been updated by more UEs, this may be detected by finding the number of UEs that have updated the column for CGIID that is bound to increase monotonically, that update may then be pushed instead of a stale one.

The summary process may be understood to be the sum of two hashtables and, as such, it may be performed by summing, e.g., numerically adding, the contents of each key with the corresponding key that may be created locally when the UE measures for signal strength. If the key is missing, then zero may be added, and an entry may be created for it in the final result, that is, as in key4 and key8 in the example bellow.
HashTable 1 {“key1”: val1, “key2”: val2, “key4”: val3}
HashTable 2 {“key2”: val4, “key1”: val5, “key8”: val6}
HashTable 1+2 {“key1”: val+val5, “key2” val2+val4, “key4”: val3, “key8”: val6}
   Improving heterogeneity of updates-avoiding sending to the network node 110 information that it may already know.

It may be possible, particularly in the case of static UEs, that the measurements they receive when scanning for nearby cells is always the same, for example, for static UEs in static environments. To overcome this issue, the previous algorithms may be amended to remember the last local update that has been made by the UE and, if the new update is different than the local update, only then may the UE share its measurements. Otherwise, it may just propagate the message it has received to the next UE. In addition, it may increment an additional field in the Compilation Request (CR), participants which marks the number of UEs that have participated in the process regardless of if they have added their input or not.

This amended algorithm may comprise a new parameters:
last_local_update: this parameter may be understood to be session agnostic. It may be understood to record the last measurement update that has been shared by this UE—this feature may be used to check if the UE is sending something that the network node 110, e.g., an eNB, has not seen before not just for this session, but also for other sessions that have happened in the past.

```
do forever
  CR <− waitForCGIRequest(FAN_IN)
  if criteria is True and CR.CGIID == CGIID
// the request is coming from a device that is connected to the same cell and if enough battery
    if (CR.sessionId not in session)
// this is the first request for this session
      sessions <+ CR.sessionID
      // append sessionID
      m <− measure_neighbouring_cells( )
      if last_local_update != m
        m′ <− CR.m + m
        CR.m = m′
        last_update <− m′
      else
        CR.m <− last_update
      last_local_update <− CR.m
      CR.participants <− CR.participants + 1
      if (CR.participants > MAX)
// if we have reviewed all UEs in the same cell
          send(CR.m, CGIID)
      else
// we propagate this message further
          broadcast_measurements(CR)
    else:
      if (m′[CGID] > last_update[CGIID])
// the information has been updated by more UEs than the last update including this UE
      last_update <− m
      CR.participants <− CR.participants + 1
      broadcast_measurements(CR)
```

### Receiving Thread

It may be understood that the details of the non-limiting examples just described may equally apply, and be combined, as pertinent, with the methods described in relation to FIG. 3, FIG. 4 and FIG. 5.

Certain embodiments disclosed herein may provide one or more of the following technical advantage(s), which may be summarized as follows. As a first advantage, embodiments herein, may be understood to enable to automatically gather information in a cell about neighboring cells, while maintaining the privacy of the wireless devices involved. The requesting cell may receive a summary of the cells, as identified by e.g., CGIs, that each wireless device may have listened to, without knowing which wireless device may have listened to which cells, as identified by e.g., CGI, specifically. The wireless devices that participate may be understood to not know the identity of the other wireless devices, since that information is not communicated-both parties, the network node 110 and the wireless devices, may be assumed to be distrusting.

As a second advantage, embodiments herein, may be understood to enable that the requesting network node 110 and/or cell may be offloaded by the process of querying each wireless device that may have an active connection with it, in order to get such information. Instead, the process may now be delegated to the wireless devices, and the network node 110, via the requesting cell, may only receive the final result. The offloading here may be understood to represent less energy consumption for the network node 110, less signalling and smaller computation cost. To achieve the same benefits on the wireless device side, wireless devices may check how much battery they have at their disposal, or the computational resources, and opt-in/opt-out accordingly.

As a further advantage, embodiments herein may be generalized to other technologies, that is, other than cellular technologies, such as Wifi and Bluetooth, where similar discovery mechanisms exist.

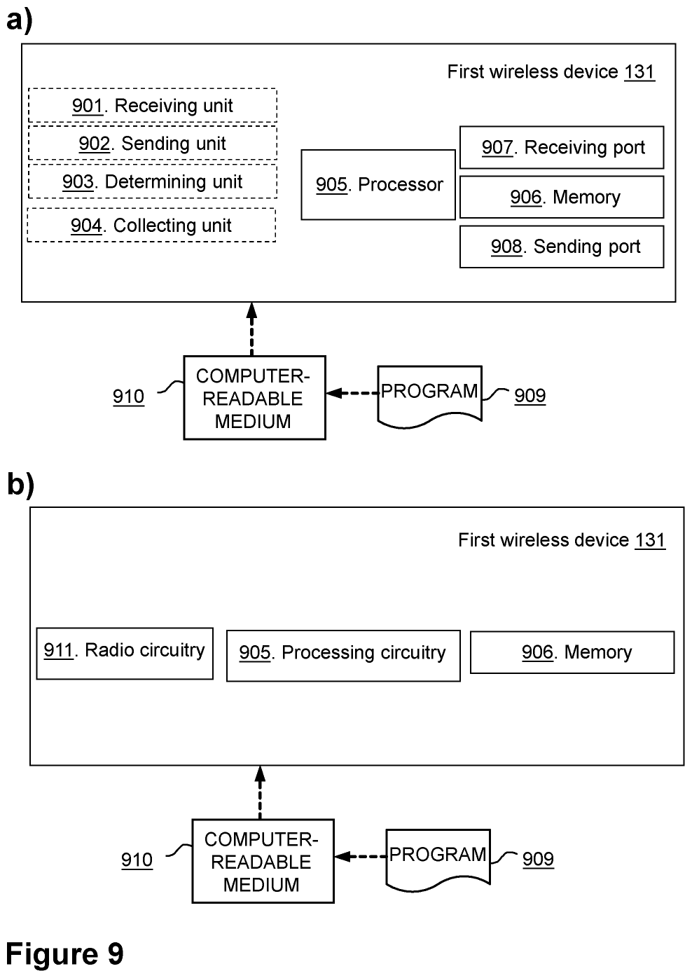

FIG. 9 depicts two different examples in panels a) and b), respectively, of the arrangement that the first wireless device 131 may comprise to perform the method actions described above in relation to FIG. 3. In some embodiments, the first wireless device 131 may comprise the following arrangement depicted in FIG. 9a. The first wireless device 131 may be understood to be for handling detection of cells neighboring the first cell 121 configured to serve the first wireless device 131. The first wireless device 131 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first wireless device 131 and will thus not be repeated here. For example, the first indication may be configured to be, e.g., a CGI ID.

In FIG. 9, optional units are indicated with dashed boxes.

The first wireless device 131 is configured to, e.g. by means of a receiving unit 901 within the first wireless device 131, configured to receive, from the another wireless device 134 configured to operate in the wireless communications network 100, via device to device communication, a) the first request to collect one or more respective measurements on cells configured to be detected by the first wireless device 131, b) the first indication configured to indicate the first cell 121 configured to be served by the network node 110 that the request for the one or more respective measurements is configured to originate from, and c) the second indication configured to indicate the session to which the request is configured to belong.

The first wireless device 131 is also configured to, e.g. by means of a sending unit 902, configured to send, to at least the second wireless device 132 configured to operate in the wireless communications network 100, via device to device communication, a) the second request to collect one or more respective measurements on cells configured to be detected by the second wireless device 132, b) the first indication being configured to indicate the first cell 121 configured to be served by the network node 110 that the request for the one or more respective measurements is configured to originate from, and c) the second indication configured to indicate the session to which the request is configured to belong.

In some embodiments, the first wireless device 131 may be configured to, e.g. by means of the receiving unit 901 within the first wireless device 131, configured to, receive, from the network node 110 via the first cell 121, a) the earlier request to collect the one or more respective measurements on cells configured to be detected by the first wireless device 131, b) the first indication, and c) the second indication.

In some embodiments, the first wireless device 131 may be configured to, e.g. by means of the sending unit 902 within the first wireless device 131, configured to, send, to at least the third wireless device 133 configured to operate in the wireless communications network 100, via device to device communication, a) the further request to collect one or more respective measurements on cells configured to be detected by the third wireless device 133, b) the first indication configured to indicate the first cell 121 the further request for the one or more respective measurements is configured to originate from, and c) the second indication configured to indicate the session to which the further request may be configured to belong, wherein the sending of the further request may be configured to be based on the earlier request configured to be received.

In some embodiments, the first wireless device 131 may be configured to, e.g. by means of a determining unit 903 within the first wireless device 131, configured to, determine, based on the first request configured to be received, at least one of: i) whether the previous first request has already been received for the indicated session, ii) whether the first wireless device 131 is served by the first cell 121, iii) whether or not the one or more conditions are met, the one or more conditions being configured to comprise at least one of: the battery level of the first wireless device 131, the state of the first wireless device 131 and the location of the wireless device 91, and iv) whether or not the map of physical cell global identifiers may be comprised for the identified session in the first request that may have been received.

In some embodiments, the first wireless device 131 may be configured to, e.g. by means of a collecting unit 904 within the first wireless device 131, configured to, collect, based on the result of the determination of at least one of i-iv, and further based on the first request configured to be received, the one or more respective measurements on the cells configured to be detected by the first wireless device 131. The second request configured to be sent to at least the second wireless device 132 may be configured to comprise the third indication configured to indicate the collected one or more respective measurements on the cells configured to be detected by the first wireless device 131.

In some embodiments, the first wireless device 131 may be configured to, e.g. by means of the determining unit 903 within the first wireless device 131, configured to, determine, after collecting the one or more respective measurements, and prior to sending the second request to the second wireless device 132, whether or not the maximum number of wireless devices may have been reached. In some of these embodiments, the sending of the second request may be configured to be performed with the proviso that the maximum number of wireless devices may have not been reached.

In some embodiments, the first wireless device 131 may be configured to, e.g. by means of the sending unit 902 within the first wireless device 131, configured to, send, via device to device communication, to at least the second wireless device 132, the fourth indication configured to indicate the type of application configured to be supported by the first wireless device 131 to support automatically handling neighbor relations.

In some embodiments, the first wireless device 131 may be configured to, e.g. by means of the receiving unit 901 within the first wireless device 131, configured to, receive, based on the fourth indication configured to be sent, and via device to device communication, the first connection request from the second wireless device 132. The sending of the request to the second wireless device 132 may be configured to be based on the first connection request configured to be received.

In some embodiments, the first wireless device 131 may be configured to, e.g. by means of the receiving unit 901 within the first wireless device 131, configured to, receive, from the network node 110 via the first cell 121, the allocation of time-frequency resources for performing device to device communications for the session configured to be indicated.

In some embodiments, the first wireless device 131 may be configured to, e.g. by means of the receiving unit 901 within the first wireless device 131, configured to, receive, via device to device communication and after sending the second request, from at least the second wireless device 132, the fifth indication configured to indicate to tear down the device to device communication for the session configured to be indicated with the second wireless device 132.

In some embodiments, the device to device communication may be configured to be performed according to a gossip protocol.

In some embodiments, the first wireless device 131 may be further configured to refrain from providing its identity to the second wireless device 132.

The embodiments herein in the first wireless device 131 may be implemented through one or more processors, such as a processor 905 in the first wireless device 131 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first wireless device 131. One such carrier may be in the form of a CD ROM disc. It is however feasible with other data carriers such as a memory stick. The computer program code may furthermore be provided as pure program code on a server and downloaded to the first wireless device 131.

The first wireless device 131 may further comprise a memory 906 comprising one or more memory units. The memory 906 is arranged to be used to store obtained information, store data, configurations, schedulings, and applications etc. to perform the methods herein when being executed in the first wireless device 131.

In some embodiments, the first wireless device 131 may receive information from, e.g., the network node 110, the second wireless device 132, the third wireless device 133, the another wireless device 134, other wireless devices, and/or any of the neighboring cells, through a receiving port 907. In some embodiments, the receiving port 907 may be, for example, connected to one or more antennas in first wireless device 131. In other embodiments, the first wireless device 131 may receive information from another structure in the wireless communications network 100 through the receiving port 907. Since the receiving port 907 may be in communication with the processor 905, the receiving port 907 may then send the received information to the processor 905. The receiving port 907 may also be configured to receive other information.

The processor 905 in the first wireless device 131 may be further configured to transmit or send information to e.g., the network node 110, the second wireless device 132, the third wireless device 133, the another wireless device 134, other wireless devices, any of the neighboring cells, and/or another structure in the wireless communications network 100, through a sending port 908, which may be in communication with the processor 905, and the memory 906.

Those skilled in the art will also appreciate that the different units 901-904 described above may refer to a combination of analog and digital modules, and/or one or more processors configured with software and/or firmware, e.g., stored in memory, that, when executed by the one or more processors such as the processor 905, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-904 described above may be implemented as one or more applications running on one or more processors such as the processor 905.

Thus, the methods according to the embodiments described herein for the first wireless device 131 may be respectively implemented by means of a computer program 909 product, comprising instructions, i.e., software code portions, which, when executed on at least one processor 905, cause the at least one processor 905 to carry out the actions described herein, as performed by the first wireless device 131. The computer program 909 product may be stored on a computer-readable storage medium 910. The computer-readable storage medium 910, having stored thereon the computer program 909, may comprise instructions which, when executed on at least one processor 905, cause the at least one processor 905 to carry out the actions described herein, as performed by the first wireless device 131. In some embodiments, the computer-readable storage medium 910 may be a non-transitory computer-readable storage medium, such as a CD ROM disc, or a memory stick. In other embodiments, the computer program 909 product may be stored on a carrier containing the computer program 909 just described, wherein the carrier is one of an electronic signal, optical signal, radio signal, or the computer-readable storage medium 910, as described above.

The first wireless device 131 may comprise a communication interface configured to facilitate communications between the first wireless device 131 and other nodes or devices, e.g., the network node 110, the second wireless device 132, the third wireless device 133, the another wireless device 134, other wireless devices, any of the neighboring cells, and/or another structure in the wireless communications network 100. The interface may, for example, include a transceiver configured to transmit and receive radio signals over an air interface in accordance with a suitable standard.

In other embodiments, the first wireless device 131 may comprise the following arrangement depicted in FIG. 9b. The first wireless device 131 may comprise a processing circuitry 905, e.g., one or more processors such as the processor 905, in the first wireless device 131 and the memory 906. The first wireless device 131 may also comprise a radio circuitry 911, which may comprise e.g., the receiving port 907 and the sending port 908. The processing circuitry 911 may be configured to, or operable to, perform the method actions according to FIG. 3, FIG. 7 and/or FIG. 8, in a similar manner as that described in relation to FIG. 9a. The radio circuitry 911 may be configured to set up and maintain at least a wireless connection with the network node 110, the second wireless device 132, the third wireless device 133, the another wireless device 134, other wireless devices, any of the neighboring cells, and/or another structure in the wireless communications network 100. Circuitry may be understood herein as a hardware component.

Hence, embodiments herein also relate to the first wireless device 131 comprising the processing circuitry 905 and the memory 906, said memory 906 containing instructions executable by said processing circuitry 905, whereby the first wireless device 131 is operative to perform the actions described herein in relation to the first wireless device 131, e.g., in Figure FIG. 3, FIG. 7 and/or FIG. 8.

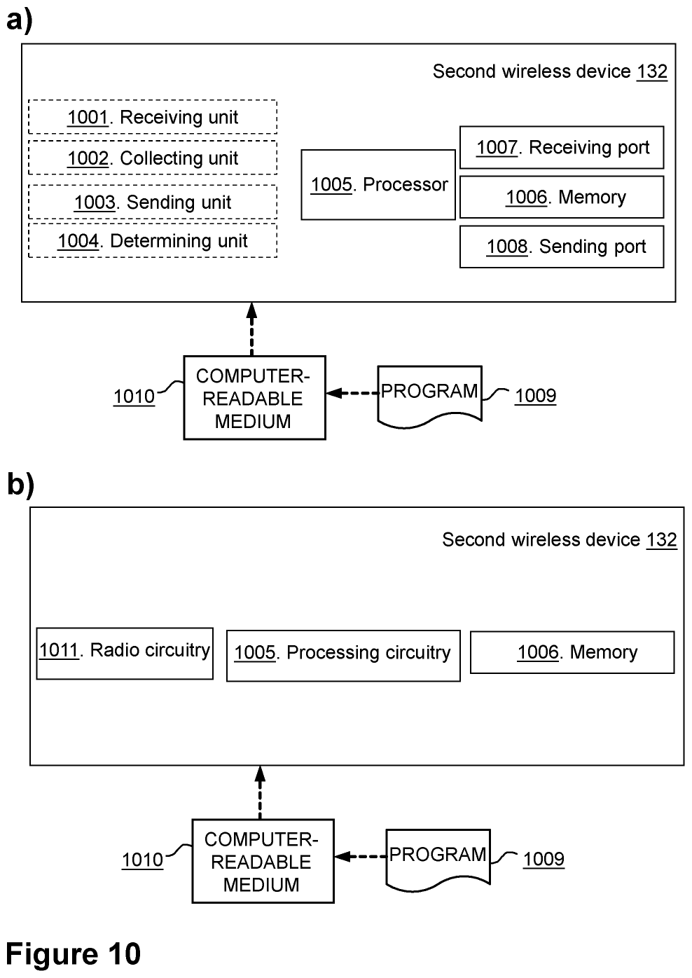

FIG. 10 depicts two different examples in panels a) and b), respectively, of the arrangement that the second wireless device 132 may comprise to perform the method actions described above in relation to FIG. 4. In some embodiments, the second wireless device 132 may comprise the following arrangement depicted in FIG. 10a. The second wireless device 132 may be understood to be for handling detection of cells neighboring the first cell 121 configured to be serving the second wireless node 132 configured to operate in the wireless communications network 100. The second wireless device 132 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second wireless device 132 and will thus not be repeated here. For example, the first indication may be configured to be, e.g., a CGI ID.

In FIG. 10, optional units are indicated with dashed boxes.

The second wireless device 132 is configured to, e.g. by means of a receiving unit 1001 within the second wireless device 132, configured to receive, from at least one first wireless device 131 configured to operate in the wireless communications network 100, via device to device communication, a) the second request to collect one or more respective measurements on cells configured to be detected by the second wireless device 132, b) the first indication configured to indicate the first cell 121 being configured to be served by the network node 110 that the request for the one or more measurements is configured to originate from, c) the second indication configured to indicate the session to which the request is configured to belong, and d) the third indication configured to indicate the one or more respective measurements on the cells configured to be detected by the first wireless device 131.

The second wireless device 132 is also configured to, e.g. by means of a collecting unit 1002, configured to collect, based on the second request configured to be received, the one or more respective measurements on cells configured to be detected by the second wireless device 132.

The second wireless device 132 is also configured to, e.g. by means of a sending unit 1003, configured to send, to the network node 110 configured to operate in the wireless communications network 100, the network node 110 being configured to serve the first cell 121, the further indication. The further indication is configured to indicate the one or more respective measurements configured to be collected on the cells configured to be detected by the second wireless device 132 and the one or more respective measurements on the cells configured to be detected by the at least one first wireless device 131.

In some embodiments, the second wireless device 132 may be configured to, e.g. by means of a determining unit 1004 within the second wireless device 132, configured to, determine, based on the second request configured to be received, at least one of: i) whether the previous first request has already been received for the indicated session, ii) whether the second wireless device 132 is served by the first cell 121, iii) whether or not the one or more conditions are met, the one or more conditions being configured to comprise at least one of: the battery level of the second wireless device 132, the state of the second wireless device 132 and the location of the second wireless device 132, and iv) whether or not the map of physical cell global identifiers may be comprised for the identified session in the first request that may have been received.

In some embodiments, the collecting in Action 406 may be based on the result of the determination of at least one of i, ii, iii and iv.

In some embodiments, the second wireless device 132 may be configured to, e.g. by means of the determining unit 1004 within the second wireless device 132, configured to, determine, after collecting the one or more respective measurements, whether or not the maximum number of wireless devices has been reached. In some of such embodiments, the sending of the further indication may be configured to be performed with the proviso that the maximum number of wireless devices may have been reached.

In some embodiments, the second wireless device 132 may be configured to receive the plurality of respective requests from the plurality of first wireless devices 130. Each of the respective requests may be configured to comprise the respective one or more respective measurements configured to be collected by the respective first wireless devices in the plurality of first wireless devices 130. The further request configured to be sent may be configured to comprise the compilation of all received one or more respective measurements, with the proviso that of measurements performed on the same cell, only the most recent measurement may be configured to be included in the sent further request.

In some embodiments, with the proviso that the maximum number of wireless devices may not have been reached, the second wireless device 132 may be configured to, e.g. by means of the receiving unit 1001 within the second wireless device 132, configured to, receive, via device to device communication, from the first wireless device 131, the fourth indication configured to indicate the type of application configured to be supported by the first wireless device 131 to support automatically handling neighbor relations.

In some embodiments, with the proviso that the maximum number of wireless devices may not have been reached, the second wireless device 132 may be configured to, e.g. by means of the sending unit 1003 within the second wireless device 132, configured to, send, based on the fourth indication configured to be received and via device to device communication, the first connection request to the first wireless device 131. The receiving of the second request from the first wireless device 131 may be configured to be based on the first connection request configured to be sent.

In some embodiments, the second wireless device 132 may be configured to, e.g. by means of the receiving unit 1001 within the second wireless device 132, configured to, receive, from the network node 110 via the first cell 121, the allocation of time-frequency resources for performing device to device communications for the session configured to be indicated.

In some embodiments, the second wireless device 132 may be configured to, e.g. by means of the sending unit 1003 within the second wireless device 132, configured to, send, via device to device communication and after receiving the second request, to the first wireless device 131, the fifth indication configured to indicate to tear down the device to device communication for the session configured to be indicated, with the first wireless device 131.

In some embodiments, the device to device communication may be configured to be performed according to a gossip protocol.

In some embodiments, the first wireless device 131 may be further configured to refrain from providing its identity to the second wireless device 132.

The embodiments herein in the second wireless device 132 may be implemented through one or more processors, such as a processor 1005 in the second wireless device 132 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second wireless device 132. One such carrier may be in the form of a CD ROM disc. It is however feasible with other data carriers such as a memory stick. The computer program code may furthermore be provided as pure program code on a server and downloaded to the second wireless device 132.

The second wireless device 132 may further comprise a memory 1006 comprising one or more memory units. The memory 1006 is arranged to be used to store obtained information, store data, configurations, schedulings, and applications etc. to perform the methods herein when being executed in the second wireless device 132.

In some embodiments, the second wireless device 132 may receive information from, e.g., the network node 110, the first wireless device 131, the third wireless device 133, the another wireless device 134, other wireless devices, and/or any of the neighboring cells, through a receiving port 1007. In some embodiments, the receiving port 1007 may be, for example, connected to one or more antennas in second wireless device 132. In other embodiments, the second wireless device 132 may receive information from another structure in the wireless communications network 100 through the receiving port 1007. Since the receiving port 1007 may be in communication with the processor 1005, the receiving port 1007 may then send the received information to the processor 1005. The receiving port 1007 may also be configured to receive other information.

The processor 1005 in the second wireless device 132 may be further configured to transmit or send information to e.g., the network node 110, the first wireless device 131, the third wireless device 133, the another wireless device 134, other wireless devices, any of the neighboring cells, and/or another structure in the wireless communications network 100, through a sending port 1008, which may be in communication with the processor 1005, and the memory 1006.

Those skilled in the art will also appreciate that the different units 1001-1004 described above may refer to a combination of analog and digital modules, and/or one or more processors configured with software and/or firmware, e.g., stored in memory, that, when executed by the one or more processors such as the processor 1005, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1001-1004 described above may be implemented as one or more applications running on one or more processors such as the processor 1005.

Thus, the methods according to the embodiments described herein for the second wireless device 132 may be respectively implemented by means of a computer program 1009 product, comprising instructions, i.e., software code portions, which, when executed on at least one processor 1005, cause the at least one processor 1005 to carry out the actions described herein, as performed by the second wireless device 132. The computer program 1009 product may be stored on a computer-readable storage medium 1010. The computer-readable storage medium 1010, having stored thereon the computer program 1009, may comprise instructions which, when executed on at least one processor 1005, cause the at least one processor 1005 to carry out the actions described herein, as performed by the second wireless device 132. In some embodiments, the computer-readable storage medium 1010 may be a non-transitory computer-readable storage medium, such as a CD ROM disc, or a memory stick. In other embodiments, the computer program 1009 product may be stored on a carrier containing the computer program 1009 just described, wherein the carrier is one of an electronic signal, optical signal, radio signal, or the computer-readable storage medium 1010, as described above.

The second wireless device 132 may comprise a communication interface configured to facilitate communications between the second wireless device 132 and other nodes or devices, e.g., the network node 110, the first wireless device 131, the third wireless device 133, the another wireless device 134, other wireless devices, any of the neighboring cells, and/or another structure in the wireless communications network 100. The interface may, for example, include a transceiver configured to transmit and receive radio signals over an air interface in accordance with a suitable standard.

In other embodiments, the second wireless device 132 may comprise the following arrangement depicted in FIG. 10b. The second wireless device 132 may comprise a processing circuitry 1005, e.g., one or more processors such as the processor 1005, in the second wireless device 132 and the memory 1006. The second wireless device 132 may also comprise a radio circuitry 1011, which may comprise e.g., the receiving port 1007 and the sending port 1008. The processing circuitry 1011 may be configured to, or operable to, perform the method actions according to FIG. 4, FIG. 7 and/or FIG. 8, in a similar manner as that described in relation to FIG. 10a. The radio circuitry 1011 may be configured to set up and maintain at least a wireless connection with the network node 110, the first wireless device 131, the third wireless device 133, the another wireless device 134, other wireless devices, any of the neighboring cells, and/or another structure in the wireless communications network 100. Circuitry may be understood herein as a hardware component.

Hence, embodiments herein also relate to the second wireless device 132 comprising the processing circuitry 1005 and the memory 1006, said memory 1006 containing instructions executable by said processing circuitry 1005, whereby the second wireless device 132 is operative to perform the actions described herein in relation to the second wireless device 132, e.g., in FIG. 4, FIG. 7 and/or FIG. 8.

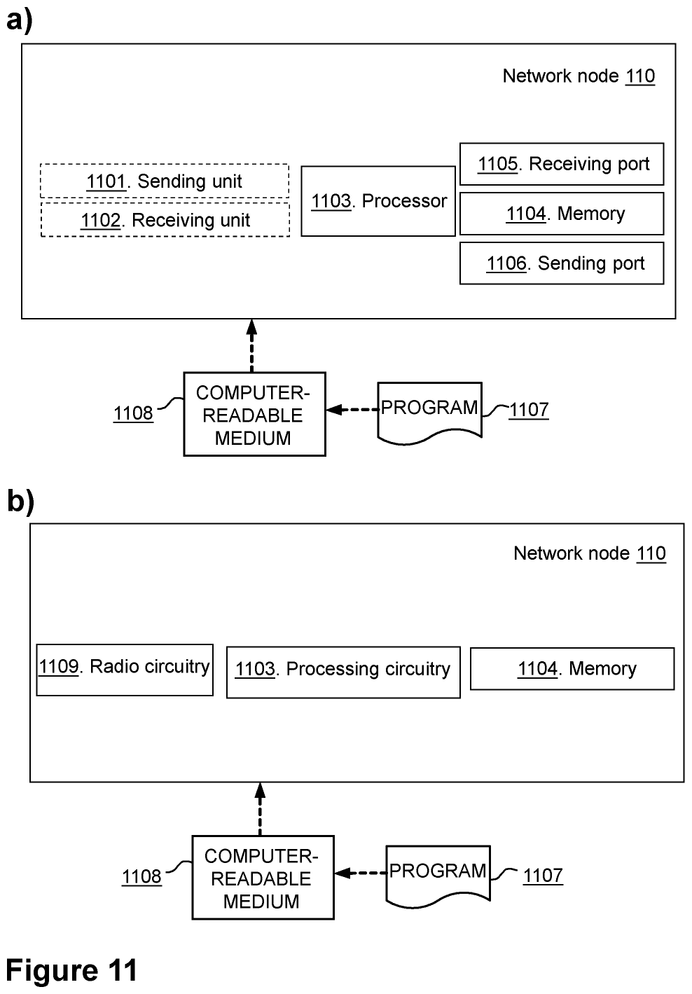

FIG. 11 depicts two different examples in panels a) and b), respectively, of the arrangement that the network node 110 may comprise to perform the method actions described above in relation to FIG. 5. In some embodiments, the network node 110 may comprise the following arrangement depicted in FIG. 11a. The network node 110 may be understood to be for handling detection of cells neighboring the first cell 121. The network node 110 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first wireless device 131 and the network node 110, and will thus not be repeated here. For example, the first indication may be configured to be, e.g., a CGI ID.

In FIG. 11, optional units are indicated with dashed boxes.

The network node 110 is configured to, e.g. by means of a sending unit 1101 within the network node 110, configured to, send, to at least the wireless device 131, 133 configured to operate in the wireless communications network 100, a) the request to collect one or more respective measurements on cells configured to be detected by the wireless device 131, 133, b) the first indication configured to indicate the first cell 121, and c) the second indication configured to indicate the session to which the first request is configured to belong.

The network node 110 is configured to, e.g. by means of a receiving unit 1102 within the network node 110, configured receive, from the different wireless device 132, the further indication configured to indicate one or more respective measurements configured to be collected on cells configured to be detected by at least the wireless device 131 and the different wireless device 132—The receiving may be configured to be performed in the absence of receiving the respective identity of the wireless device 131 and the different wireless device 132.

In some embodiments, the network node 110 may be configured to, e.g. by means of the sending unit 1101 configured to, send, to at least one of the wireless device 131, 133 and the different wireless device 132, the allocation of time-frequency resources for performing device to device communications for the session configured to be indicated.

The embodiments herein in the network node 110 may be implemented through one or more processors, such as a processor 1103 in the network node 110 depicted in FIG. 11a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 1104 comprising one or more memory units. The memory 1104 is arranged to be used to store obtained information, store data, configurations, schedulings, and applications etc. to perform the methods herein when being executed in the network node 110.

In some embodiments, the network node 110 may receive information from, e.g., the first wireless device 131, the first wireless device 131, the third wireless device 133, the another wireless device 134, other wireless devices, and/or any of the neighboring cells, through a receiving port 1105. In some embodiments, the receiving port 1105 may be, for example, connected to one or more antennas in network node 110. In other embodiments, the network node 110 may receive information from another structure in the wireless communications network 100 through the receiving port 1105. Since the receiving port 1105 may be in communication with the processor 1103, the receiving port 1105 may then send the received information to the processor 1103. The receiving port 1105 may also be configured to receive other information.

The processor 1103 in the network node 110 may be further configured to transmit or send information to e.g., the first wireless device 131, the first wireless device 131, the third wireless device 133, the another wireless device 134, other wireless devices, any of the neighboring cells, and/or another structure in the wireless communications network 100, through a sending port 1106, which may be in communication with the processor 1103, and the memory 1104.

Those skilled in the art will also appreciate that the different units 1101-1102 described above may refer to a combination of analog and digital modules, and/or one or more processors configured with software and/or firmware, e.g., stored in memory, that, when executed by the one or more processors such as the processor 1103, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1101-1102 described above may be implemented as one or more applications running on one or more processors such as the processor 1103.

Thus, the methods according to the embodiments described herein for the network node 110 may be respectively implemented by means of a computer program 1107 product, comprising instructions, i.e., software code portions, which, when executed on at least one processor 1103, cause the at least one processor 1103 to carry out the actions described herein, as performed by the network node 110. The computer program 1107 product may be stored on a computer-readable storage medium 1108. The computer-readable storage medium 1108, having stored thereon the computer program 1107, may comprise instructions which, when executed on at least one processor 1103, cause the at least one processor 1103 to carry out the actions described herein, as performed by the network node 110. In some embodiments, the computer-readable storage medium 1108 may be a non-transitory computer-readable storage medium, such as a CD ROM disc, or a memory stick. In other embodiments, the computer program 1107 product may be stored on a carrier containing the computer program 1107 just described, wherein the carrier is one of an electronic signal, optical signal, radio signal, or the computer-readable storage medium 1108, as described above.

The network node 110 may comprise a communication interface configured to facilitate communications between the network node 110 and other nodes or devices, e.g., the first wireless device 131, the first wireless device 131, the third wireless device 133, the another wireless device 134, other wireless devices, any of the neighboring cells, and/or another structure in the wireless communications network 100. The interface may, for example, include a transceiver configured to transmit and receive radio signals over an air interface in accordance with a suitable standard.

In other embodiments, the network node 110 may comprise the following arrangement depicted in FIG. 11b. The network node 110 may comprise a processing circuitry 1103, e.g., one or more processors such as the processor 1103, in the network node 110 and the memory 1104. The network node 110 may also comprise a radio circuitry 1109, which may comprise e.g., the receiving port 1105 and the sending port 1106. The processing circuitry 1103 may be configured to, or operable to, perform the method actions according to FIG. 5 and/or FIG. 7, in a similar manner as that described in relation to FIG. 11a. The radio circuitry 1109 may be configured to set up and maintain at least a wireless connection with the first wireless device 131, the first wireless device 131, the third wireless device 133, the another wireless device 134, other wireless devices, any of the neighboring cells, and/or another structure in the wireless communications network 100. Circuitry may be understood herein as a hardware component.

Hence, embodiments herein also relate to the network node 110 comprising the processing circuitry 1103 and the memory 1104, said memory 1104 containing instructions executable by said processing circuitry 1103, whereby the network node 110 is operative to perform the actions described herein in relation to the network node 110, e.g., in FIG. 5 and/or FIG. 7.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

1. A method performed by a first wireless device, the method being for handling detection of cells neighboring a first cell serving the first wireless device, the first wireless device operating in a wireless communications network, the method comprising:
receiving, from another wireless device operating in the wireless communications network, via device to device communication, a) a first request to collect one or more respective measurements on cells detected by the first wireless device, b) a first indication indicating the first cell served by a network node that the request for the one or more respective measurements originates from, and c) a second indication indicating a session to which the request belongs; and
sending, to at least a second wireless device operating in the wireless communications network, via device to device communication, a) a second request to collect one or more respective measurements on cells detected by the second wireless device, b) the first indication indicating the first cell served by the network node that the request for the one or more respective measurements originates from, and c) the second indication indicating the session to which the request belongs.

2. The method of claim 1, wherein the method further comprises:
receiving, from the network node via the first cell, a) an earlier request to collect the one or more respective measurements on cells detected by the first wireless device, b) the first indication, and c) the second indication, and
sending, to at least a third wireless device operating in the wireless communications network, via device to device communication, a) a further request to collect one or more respective measurements on cells detected by the third wireless device, b) the first indication indicating the first cell the further request for the one or more respective measurements originates from, and c) the second indication indicating the session to which the further request belongs, wherein the sending of the further request is based on the received earlier request.

3. The method of claim 1, wherein the method further comprises:
based on the received first request, determining:
i) whether a previous first request has already been received for the indicated session,
ii) whether the first wireless device is served by the first cell,
iii) whether or not one or more conditions are met, the one or more conditions comprising at least one of: a battery level of the first wireless device, a state of the first wireless device and a location of the wireless device, and/or
iv) whether or not a map of physical cell global identifiers is comprised for the identified session in the first request that has been received; and
collecting, based on a result of the determination of at least one of i)-iv), and further based on the received first request, the one or more respective measurements on the cells detected by the first wireless device, and wherein the second request sent to at least the second wireless device comprises a third indication indicating the collected one or more respective measurements on the cells detected by the first wireless device.

4. The method of claim 3, wherein the method further comprises:
determining, after collecting the one or more respective measurements, and prior to sending the second request to the second wireless device whether or not a maximum number of wireless devices has been reached, wherein
the sending of the second request is performed with the proviso that the maximum number of wireless devices has not been reached.

5. The method of claim 1, the method further comprising:
sending, via device to device communication, to at least the second wireless device, a fourth indication indicating a type of application supported by the first wireless device to support automatically handling neighbor relations, and
receiving, based on the sent fourth indication and via device to device communication, a first connection request from the second wireless device, wherein the sending of the request to the second wireless device is based on the received first connection request.

6. The method of claim 1, the method further comprising:
receiving, from the network node via the first cell, an allocation of time-frequency resources for performing device to device communications for the indicated session.

7. The method of claim 1, the method further comprising:
receiving, via device to device communication and after sending the second request, from at least the second wireless device, a fifth indication indicating to tear down the device to device communication for the indicated session with the second wireless device.

8. The method of claim 1, wherein:
the device to device communication is performed according to a gossip protocol, and/or
the first wireless device refrains from providing its identity to the second wireless device.

9. A method performed by a second wireless device, the method being for handling detection of cells neighboring a first cell serving the second wireless device operating in a wireless communications network, the method comprising:
receiving, from at least one first wireless device operating in the wireless communications network, via device to device communication, a) a second request to collect one or more respective measurements on cells detected by the second wireless device, b) a first indication indicating a first cell served by a network node that the request for the one or more measurements originates from, c) a second indication indicating a session to which the request belongs, and d) a third indication indicating the one or more respective measurements on the cells detected by the first wireless device;
collecting, based on the received second request, the one or more respective measurements on cells detected by the second wireless device; and
sending to a network node operating in the wireless communications network, the network node serving the first cell, a further indication indicating the collected one or more respective measurements on the cells detected by the second wireless device and the one or more respective measurements on the cells detected by the at least one first wireless device.

10. The method of claim 9, wherein the method further comprises:
determining, based on the received second request, at least one of:
i) whether a previous request has already been received for the indicated session,
ii) whether the second wireless device is served by the first cell, and
iii) whether or not one or more conditions are met, the one or more conditions comprising at least one of: a battery level of the second wireless device, a state of the second wireless device and a location of the second wireless device, and
iv) whether or not a map of physical cell global identifiers is comprised for the identified session in the second request that has been received, and wherein the collecting is based on a result of the determination of at least one of i), ii), iii) and iv).

11. The method of claim 10, the method further comprising:
determining, after collecting the one or more respective measurements, whether or not a maximum number of wireless devices has been reached.

12. The method of claim 9, wherein the second wireless device receives a plurality of respective requests from a plurality of first wireless devices, each of the respective requests comprising the respective one or more respective measurements collected by the respective first wireless devices in the plurality of first wireless devices, and wherein the sent further request comprises a compilation of all received one or more respective measurements, with the proviso that of measurements performed on a same cell, only a most recent measurement is included in the sent further request.

13. The method of claim 9, the method further comprising, with the proviso that the maximum number of wireless devices has not been reached:
receiving, via device to device communication, from the first wireless device, a fourth indication indicating a type of application supported by the first wireless device to support automatically handling neighbor relations, and
sending, based on the received fourth indication and via device to device communication, a first connection request to the first wireless device, wherein the receiving of the second request from the first wireless device is based on the sent first connection request.

14. The method of claim 9, the method further comprising:
receiving, from the network node via the first cell, an allocation of time-frequency resources for performing device to device communications for the indicated session.

15. The method of claim 9, the method further comprising:
sending, via device to device communication and after receiving the second request, to the first wireless device, a fifth indication indicating to tear down the device to device communication for the indicated session with the first wireless device.

16. (canceled)

17. A method performed by a network node serving a first cell, the method being for handling detection of cells neighboring the first cell, the network node operating in a wireless communications network, the method comprising:
sending, to at least a wireless device operating in the wireless communications network, a) a request to collect one or more respective measurements on cells detected by the wireless device, b) a first indication indicating the first cell, and c) a second indication indicating a session to which the first request belongs, and
receiving, from a different wireless device, a further indication indicating collected one or more respective measurements on cells detected by at least the wireless device and the different wireless device, wherein the receiving is performed in the absence of receiving a respective identity of the wireless device and the different wireless device.

18. The method of claim 17, further comprising:
sending, to at least one of the wireless device and the different wireless device, an allocation of time-frequency resources for performing device to device communications for the indicated session.

19. A first wireless device, for handling detection of cells neighboring a first cell configured to serve the first wireless device, the first wireless device being configured to operate in a wireless communications network, the first wireless device being further configured to:
receive, from another wireless device configured to operate in the wireless communications network, via device to device communication, a) a first request to collect one or more respective measurements on cells configured to be detected by the first wireless device, b) a first indication configured to indicate the first cell configured to be served by a network node that the request for the one or more respective measurements is configured to originate from, and c) a second indication configured to indicate a session to which the request is configured to belong, and
send, to at least a second wireless device configured to operate in the wireless communications network, via device to device communication, a) a second request to collect one or more respective measurements on cells configured to be detected by the second wireless device, b) the first indication being configured to indicate the first cell configured to be served by the network node that the request for the one or more respective measurements is configured to originate from, and c) the second indication configured to indicate the session to which the request is configured to belong.

20-26. (canceled)

27. A wireless device comprising:
a transmitter;
a receiver; and
processing circuitry, wherein the wireless device is configured to perform the method of claim 9.

28-34. (canceled)

35. A network node comprising:
a transmitter;
a receiver; and
processing circuitry, wherein the wireless device is configured to perform the method of claim 17.

36. (canceled)
